(19) United States
(12) Patent Application Publication
(10) Pub. No.: US 2016/0196603 A1
(43) Pub. Date: Jul. 7, 2016

(54) PRODUCT AUGMENTATION AND ADVERTISING IN SEE THROUGH DISPLAYS

(71) Applicant: Microsoft Technology Licensing, LLC, Redmond, WA (US)

(72) Inventors: Kathryn Stone Perez, Kirkland, WA (US); John Clavin, Seattle, WA (US); Kevin A. Geisner, Mercer Island, WA (US); Stephen G. Latta, Seattle, WA (US); Brian J. Mount, Seattle, WA (US); Arthur C. Tomlin, Bellevue, WA (US); Adam G. Poulos, Redmond, WA (US)

(21) Appl. No.: 14/992,867

(22) Filed: Jan. 11, 2016

Related U.S. Application Data
(63) Continuation of application No. 13/464,944, filed on May 4, 2012, now abandoned.

(51) Int. Cl. G06Q 30/06; G02B 27/01; G06Q 30/02; G02B 27/00; G06F 3/0481; G06T 19/00; G06F 3/16

(52) U.S. Cl. CPC G06Q 30/0639; G06T 19/006; G02B 27/017; G06F 3/16; G02B 27/0093; G06F 3/0481; G06Q 30/0251

(57) ABSTRACT

An augmented reality system that provides augmented product and environment information to a wearer of a see through head mounted display. The augmentation information may include advertising, inventory, pricing and other information about products a wearer may be interested in. Interest is determined from wearer actions and a wearer profile. The information may be used to incentivize purchases of real world products by a wearer, or allow the wearer to make better purchasing decisions. The augmentation information may enhance a wearer's shopping experience by allowing the wearer easy access to important product information while the wearer is shopping in a retail establishment. Through virtual rendering, a wearer may be provided with feedback on how an item would appear in a wearer environment, such as the wearer's home.

### CLAIM OF PRIORITY

This application is a continuation of U.S. patent application Ser. No. 13/464,944 filed on May 4, 2012 entitled PRODUCT AUGMENTATION AND ADVERTISING IN SEE THROUGH DISPLAYS, which application is incorporated herein by reference in its entirety.

### BACKGROUND

Augmented reality is a technology that allows virtual imagery to be mixed with a real world physical environment. An augmented reality system can be used to insert virtual images before the eyes of a wearer. In many cases, augmented reality systems do not present a view of the real world beyond the virtual images presented.

Product advertising has become focused to user activities both in visiting retail establishments and while visiting on-line shopping sites.

### SUMMARY

Technology described herein provides various embodiments for implementing an augmented reality system that can provide augmented product and environment information to a wearer. The augmentation information may include advertising, inventory, pricing and other information about products a wearer may be interested in. Interest is determined from wearer actions and a wearer profile. The information may be used to incentivize purchases of real world products by a wearer, or allow the wearer to make better purchasing decisions. The augmentation information may enhance a wearer's shopping experience by allowing the wearer easy access to important product information while the wearer is shopping in a retail establishment. In addition, when a wearer is at the wearer's home or office, a virtual rendering of an item can be shown relative to the user's view of the space and through virtual rendering, a wearer may be provided with feedback on how an item would appear in the real world environment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram depicting example components of one embodiment of a see-through, mixed reality display device with adjustable IPD in a system environment in which the device may operate.

FIG. 1B is a block diagram depicting example components of another embodiment of a see-through, mixed reality display device with adjustable IPD.

FIG. 2A is a top view illustrating examples of gaze vectors extending to a point of gaze at a distance and a direction for aligning a far IPD.

FIG. 2B is a top view illustrating examples of gaze vectors extending to a point of gaze at a distance and a direction for aligning a near IPD.

FIG. 3A is a flowchart of a method embodiment for aligning a see-through, near-eye, mixed reality display with an IPD.

FIG. 3B is a flowchart of an implementation example of a method for adjusting a display device for bringing the device into alignment with a wearer IPD.

FIG. 3C is a flowchart illustrating different example options of mechanical or automatic adjustment of at least one display adjustment mechanism.

FIG. 4A is a side view of an eyeglass temple in an eyeglasses embodiment of a mixed reality display device providing support for hardware and software components.

FIG. 4B is a side view of an eyeglass temple in an embodiment of a mixed reality display device providing support for hardware and software components and three dimensional adjustment of a microdisplay assembly.

FIG. 5A is a top view of an embodiment of a movable display optical system of a see-through, near-eye, mixed reality device including an arrangement of gaze detection elements.

FIG. 5B is a top view of another embodiment of a movable display optical system of a see-through, near-eye, mixed reality device including an arrangement of gaze detection elements.

FIG. 5C is a top view of a third embodiment of a movable display optical system of a see-through, near-eye, mixed reality device including an arrangement of gaze detection elements.

FIG. 5D is a top view of a fourth embodiment of a movable display optical system of a see-through, near-eye, mixed reality device including an arrangement of gaze detection elements.

FIG. 6A is a block diagram of one embodiment of hardware and software components of a see-through, near-eye, mixed reality display unit as may be used with one or more embodiments.

FIG. 6B is a block diagram of one embodiment of the hardware and software components of a processing unit associated with a see-through, near-eye, mixed reality display unit.

FIG. 7 is a block diagram of a system embodiment for determining positions of objects within a wearer field of view of a see-through, near-eye, mixed reality display device.

FIG. 8 is a flowchart of a method embodiment for determining a three-dimensional wearer field of view of a see-through, near-eye, mixed reality display device.

FIG. 9 is a block diagram of a system suitable for use with the present technology.

FIG. 10A is a flowchart illustrating a general method employed with the present technology.

FIG. 10B is a flowchart illustrating a second general method employed with the present technology.

FIG. 11 is a flowchart illustrating one embodiment for implementing the method of FIG. 10.

FIG. 12 is a flowchart illustrating one of the steps of FIG. 11 in additional detail.

FIG. 13 is a flowchart illustrating an alternative embodiment of the step of FIG. 12.

FIG. 14 is a flowchart illustrating one method for performing another of the steps of FIG. 11.

FIG. 15 illustrates a process for using wearer feedback with the system of the present technology.

FIG. 16 illustrates the interaction between a personal display apparatus 2 and a supplemental information provider 903.

FIG. 17 illustrates a method for providing advertising information as a specific implementation of augmentation information in accordance with the technology described herein.

FIG. 18 illustrates one possible view of a wearer wearing a see through head mounted display who has entered a real world store.

FIGS. 19-22 illustrate other possible views for a wearer wearing a see through head mounted display of a real world store.

FIG. 23 illustrates a wearer in a second physical showroom of real products.

FIGS. 24-25 illustrate other possible views for a wearer wearing a see through head mounted display in the showroom.

FIGS. 24-26 illustrate a wearer shopping experience when wearing a see through head mounted display in the showroom.

FIGS. 27 and 28 illustrate different types of data which can be shown in a see through head mounted display in a presentation to the wearer of the display.

FIG. 29 illustrates a wearer walking past a store.

FIGS. 30-31 illustrate possible views for a wearer wearing a see through head mounted display of advertising proximate to the store as the wearer passes.

FIG. 32 illustrates a block diagram of a mobile processing device.

FIG. 33 illustrates a block diagram of a gaming console processing device.

### DETAILED DESCRIPTION

The technology described herein incudes a see-through, near-eye, mixed reality display device for providing customized augmented information in the form of product information and advertising to a wearer. The system can be used in various environments, from the wearer's home to public areas and retail establishments to provide a mixed reality experience enhancing the wearer's ability to live and work.

Augmentation information can take many forms and include, for example targeted advertising based on wearer context. Using data from the STHMD, information to provide targeted advertising based on the context of wearer place and interaction is presented to the field of view of a wearer. This can include queuing ads based on time, surrounding audio, place, and wearer profile knowledge. For example, interactive ads can be triggered when a wearer is proximate to a real world object or walking by billboard. The technology further provides heat mapping of advertisements based on wearer vision, context and location. The technology can provide feedback on which ads gain the wearer's attention and for how long. This feedback can be for real world objects, virtual objects, billboards, web pages—anything the wearer views, sees or hears.

The technology can be used to provide interactive advertising. For example, a wearer walking by a billboard may be prompted to play a game when looking at the billboard to receive an additional benefit such as a coupon or prize. The technology can detect when wearer looks at a billboard and “draw a line” from the billboard to the product. STHMD can also highlight items that are on sale at a location.

In a further aspect, the technology can illustrate products in place at a wearer's home. A wearer shopping for a TV stand can have that stand placed in the wearer's home to determine how it will look in the home. A wearer can determine how they would look in the latest designer line of clothes after the device does a body scan and creates a model of the wearer, on which clothes can be drawn. This can include incentive based usage of product placement. In addition, the technology can provide wearer profile based targeted advertising based on gaze and vision within the home.

Augmentation information can provide In Store Real time Product Identification. Using the technology while shopping, a wearer can perform real time inventory checking and price checking at alternative sources. The information feed may come from third parties, competitors or be limited to the store itself. The technology can include wearer wish list mapping and shopping list mapping to location and store product availability. When wearer is in a store, the wearer's shopping list can highlight products in the store off that list. Proximity notification can let wearer know that they are close to a particular store having an item on the list.

Using the heat map advertising, Visual and Audio Feedback can be used to Change Advertisement Targeting. The technology utilizes data from the STHMD to determine when a wearer does not want to see ads about a particular product. The technology can track wearer purchases based on actual purchase data, wearer profile, location and gaze/directional tracking of items.

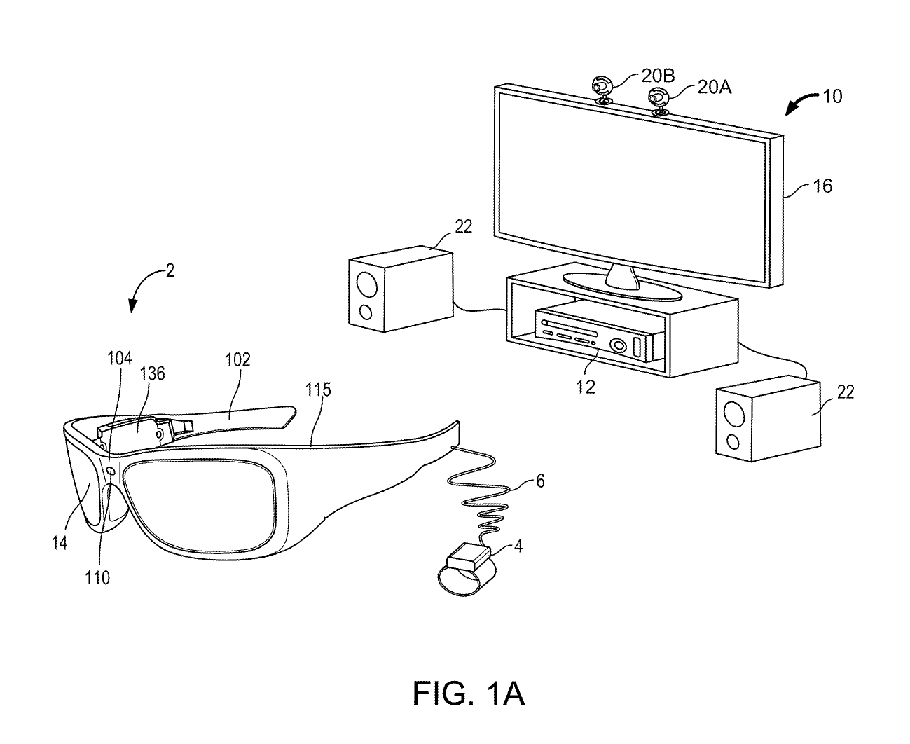

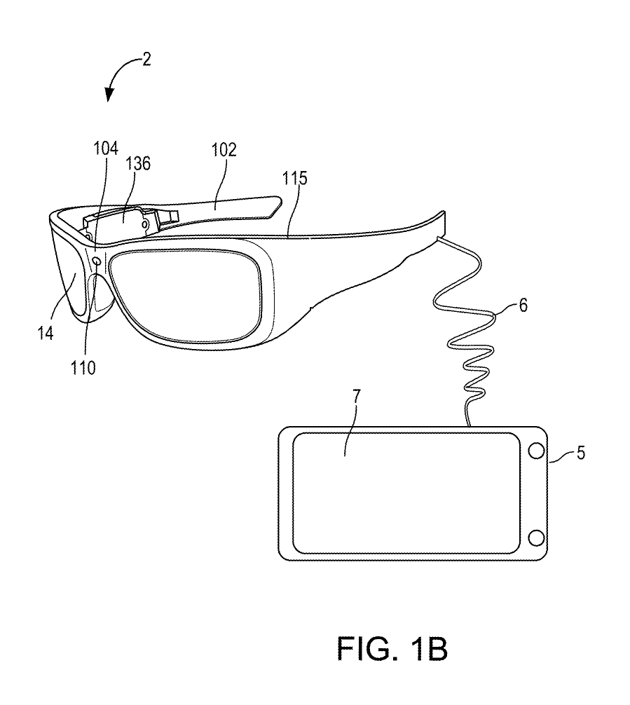

FIG. 1A is a block diagram depicting example components of one embodiment of a see-through, mixed reality display device in a system environment in which the device may operate. System 10 includes a see-through display device as a near-eye, head mounted display device 2 in communication with processing unit 4 via wire 6. In other embodiments, head mounted display device 2 communicates with processing unit 4 via wireless communication. Processing unit 4 may take various embodiments. In some embodiments, processing unit 4 is a separate unit which may be worn on the wearer's body, e.g. the wrist in the illustrated example or in a pocket, and includes much of the computing power used to operate near-eye display device 2. Processing unit 4 may communicate wirelessly (e.g., WiFi, Bluetooth, infra-red, or other wireless communication means) to one or more hub computing systems 12, hot spots, cellular data networks, etc.. In other embodiments, the functionality of the processing unit 4 may be integrated in software and hardware components of the display device 2.

See through head mounted display device 2, which in one embodiment is in the shape of eyeglasses in a frame 115, is worn on the head of a wearer so that the wearer can see through a display, embodied in this example as a display optical system 14 for each eye, and thereby have an actual direct view of the space in front of the wearer. The use of the term “actual direct view” refers to the ability to see real world objects directly with the human eye, rather than seeing created image representations of the objects. For example, looking through glass at a room allows a wearer to have an actual direct view of the room, while viewing a video of a room on a television is not an actual direct view of the room. Based on the context of executing software, for example, a gaming application, the system can project images of virtual objects, sometimes referred to as virtual images, on the display that are viewable by the person wearing the see-through display device while that person is also viewing real world objects through the display.

Frame 115 provides a support for holding elements of the system in place as well as a conduit for electrical connections. In this embodiment, frame 115 provides a convenient eyeglass frame as support for the elements of the system discussed further below. In other embodiments, other support structures can be used. An example of such a structure is a visor, hat, helmet or goggles. The frame 115 includes a temple or side arm for resting on each of a wearer's ears. Temple 102 is representative of an embodiment of the right temple and includes control circuitry 136 for the display device 2. Nose bridge 104 of the frame includes a microphone 110 for recording sounds and transmitting audio data to processing unit 4.

Hub computing system 12 may be a computer, a gaming system or console, or the like. According to an example embodiment, the hub computing system 12 may include hardware components and/or software components such that hub computing system 12 may be used to execute applications such as gaming applications, non-gaming applications, or the like. An application may be executing on hub computing system 12, the display device 2, as discussed below on a mobile device 5 or a combination of these.

In one embodiment, the hub computing system 12 further includes one or more capture devices, such as capture devices 20A and 20B. The two capture devices can be used to capture the room or other physical environment of the wearer but are not necessary for use with see through head mounted display device 2 in all embodiments.

Capture devices 20A and 20B may be, for example, cameras that visually monitor one or more wearer's and the surrounding space such that gestures and/or movements performed by the one or more wearer s, as well as the structure of the surrounding space, may be captured, analyzed, and tracked to perform one or more controls or actions within an application and/or animate an avatar or on-screen character.

Hub computing system 12 may be connected to an audiovisual device 16 such as a television, a monitor, a high-definition television (HDTV), or the like that may provide game or application visuals. In some instances, the audiovisual device 16 may be a three-dimensional display device. In one example, audiovisual device 16 includes internal speakers. In other embodiments, audiovisual device 16, a separate stereo or hub computing system 12 is connected to external speakers 22.

Note that display device 2 and processing unit 4 can be used without Hub computing system 12, in which case processing unit 4 will communicate with a WiFi network, a cellular network or other communication means.

FIG. 1B is a block diagram depicting example components of another embodiment of a see-through, mixed reality display device. In this embodiment, the near-eye display device 2 communicates with a mobile computing device 5 as an example embodiment of the processing unit 4. In the illustrated example, the mobile device 5 communicates via wire 6, but communication may also be wireless in other examples.

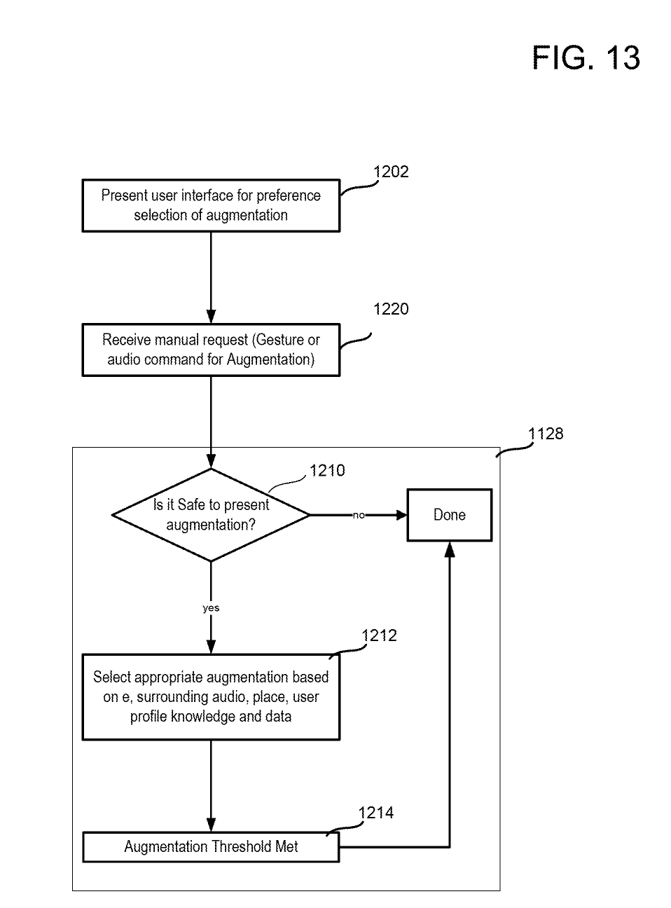

Furthermore, as in the hub computing system 12, gaming and non-gaming applications may execute on a processor of the mobile device 5 which wearer actions control or which wearer actions animate an avatar as may be displayed on a display 7 of the device 5. The mobile device 5 also provides a network interface for communicating with other computing devices like hub computing system 12 over the Internet or via another communication network via a wired or wireless communication medium using a wired or wireless communication protocol. A remote network accessible computer system like hub computing system 12 may be leveraged for processing power and remote data access by a processing unit 4 like mobile device 5. Examples of hardware and software components of a mobile device 5 such as may be embodied in a smartphone or tablet computing device are described in FIG. 20, and these components can embody the hardware and software components of a processing unit 4 such as those discussed in the embodiment of FIG. 7A. Some other examples of mobile devices 5 are a laptop or notebook computer and a netbook computer.

In some embodiments, gaze detection of each of a wearer's eyes is based on a three dimensional coordinate system of gaze detection elements on a near-eye, mixed reality display device like the eyeglasses 2 in relation to one or more human eye elements such as a cornea center, a center of eyeball rotation and a pupil center. Examples of gaze detection elements which may be part of the coordinate system including glint generating illuminators and at least one sensor for capturing data representing the generated glints. As discussed below, a center of the cornea can be determined based on two glints using planar geometry. The center of the cornea links the pupil center and the center of rotation of the eyeball, which may be treated as a fixed location for determining an optical axis of the wearer's eye at a certain gaze or viewing angle.

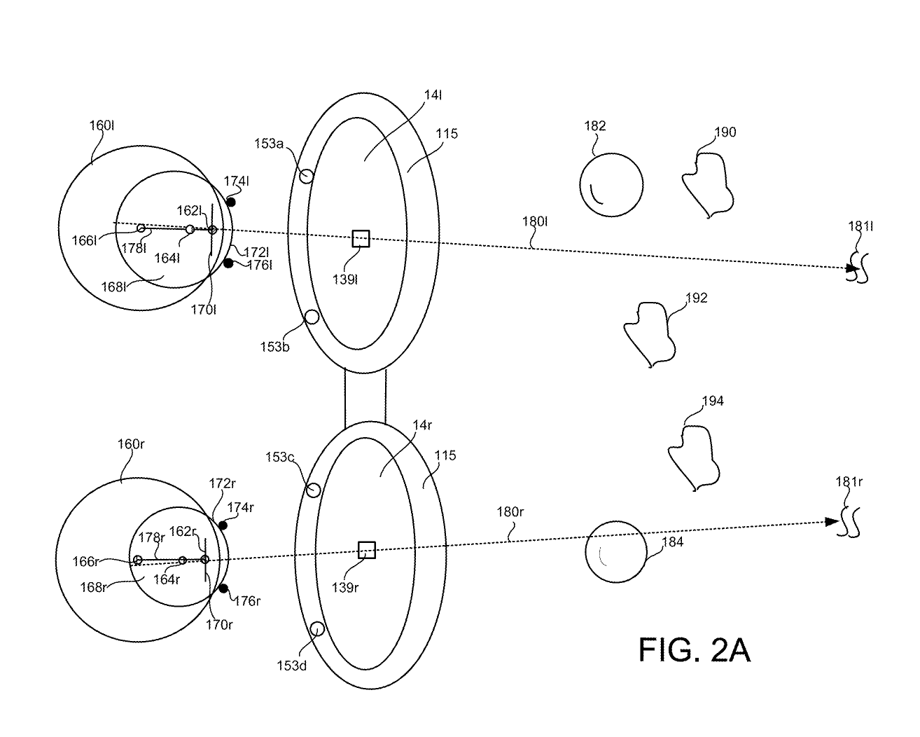

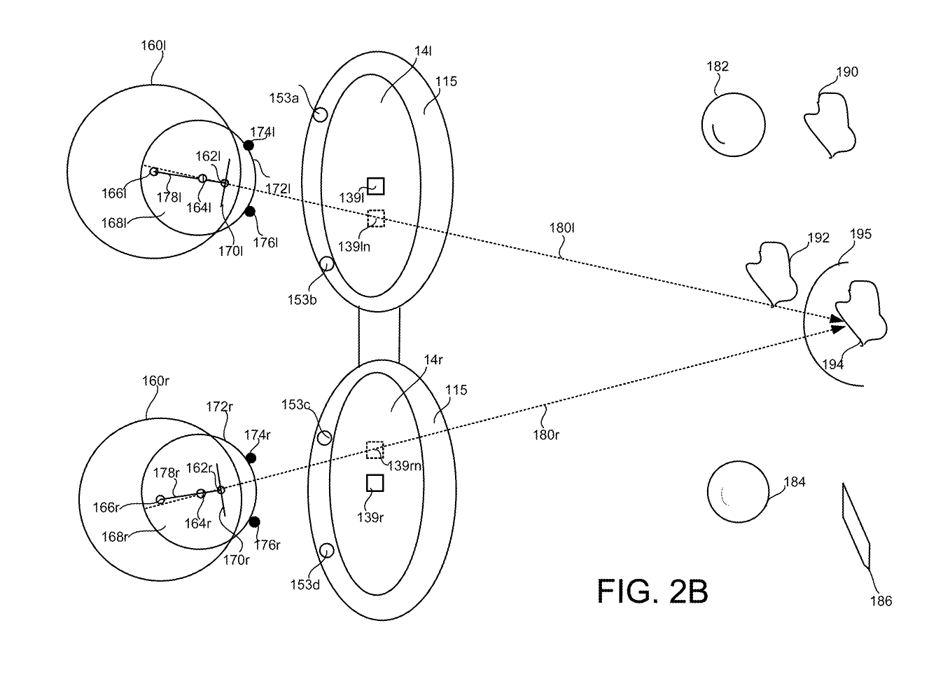

FIG. 2A is a top view illustrating examples of gaze vectors extending to a point of gaze at a distance and direction for aligning a far inter-pupillary distance (IPD). FIG. 2A illustrates examples of gaze vectors intersecting at a point of gaze where a wearer's eyes are focused effectively at infinity, for example beyond five (5) feet, or, in other words, examples of gaze vectors when the wearer is looking straight ahead. A model of the eyeball 160l, 160r is illustrated for each eye based on the Gullstrand schematic eye model. For each eye, an eyeball 160 is modeled as a sphere with a center of rotation 166 and includes a cornea 168 modeled as a sphere too and having a center 164. The cornea rotates with the eyeball, and the center 166 of rotation of the eyeball may be treated as a fixed point. The cornea covers an iris 170 with a pupil 162 at its center. In this example, on the surface 172 of the respective cornea are glints 174 and 176.

In the illustrated embodiment of FIG. 2A, a sensor detection area 139 (139l and 139r) is aligned with the optical axis of each display optical system 14 within an eyeglass frame 115. The sensor associated with the detection area is a camera in this example capable of capturing image data representing glints 174l and 176l generated respectively by illuminators 153a and 153b on the left side of the frame 115 and data representing glints 174r and 176r generated respectively by illuminators 153c and 153d. Through the display optical systems, 14l and 14r in the eyeglass frame 115, the wearer's field of view includes both real objects 190, 192 and 194 and virtual objects 182, 184, and 186.

The axis 178 formed from the center of rotation 166 through the cornea center 164 to the pupil 162 is the optical axis of the eye. A gaze vector 180 is sometimes referred to as the line of sight or visual axis which extends from the fovea through the center of the pupil 162. The fovea is a small area of about 1.2 degrees located in the retina. The angular offset between the optical axis computed and the visual axis has horizontal and vertical components. The horizontal component is up to 5 degrees from the optical axis, and the vertical component is between 2 and 3 degrees. In many embodiments, the optical axis is determined and a small correction is determined through wearer calibration to obtain the visual axis which is selected as the gaze vector.

For each wearer, a virtual object may be displayed by the display device at each of a number of predetermined positions at different horizontal and vertical positions. An optical axis may be computed for each eye during display of the object at each position, and a ray modeled as extending from the position into the wearer eye. A gaze offset angle with horizontal and vertical components may be determined based on how the optical axis must be moved to align with the modeled ray. From the different positions, an average gaze offset angle with horizontal or vertical components can be selected as the small correction to be applied to each computed optical axis. In some embodiments, only a horizontal component is used for the gaze offset angle correction.

The visual axes 180l and 180r illustrate that the gaze vectors are not perfectly parallel as the vectors become closer together as they extend from the eyeball into the field of view at a point of gaze which is effectively at infinity as indicated by the symbols 181l and 181r. At each display optical system 14, the gaze vector 180 appears to intersect the optical axis upon which the sensor detection area 139 is centered. In this configuration, the optical axes are aligned with the inter-pupillary distance (IPD). When a wearer is looking straight ahead, the IPD measured is also referred to as the far IPD.

When identifying an object for a wearer to focus on for aligning IPD at a distance, the object may be aligned in a direction along each optical axis of each display optical system. Initially, the alignment between the optical axis and wearer's pupil is not known. For a far IPD, the direction may be straight ahead through the optical axis. When aligning near IPD, the identified object may be in a direction through the optical axis, however due to vergence of the eyes necessary for close distances, the direction is not straight ahead although it may be centered between the optical axes of the display optical systems.

FIG. 2B is a top view illustrating examples of gaze vectors extending to a point of gaze at a distance and a direction for aligning a near IPD. In this example, the cornea 168l of the left eye is rotated to the right or towards the wearer's nose, and the cornea 168r of the right eye is rotated to the left or towards the wearer's nose. Both pupils are gazing at a real object 194 at a much closer distance, for example two (2) feet in front of the wearer. Gaze vectors 180l and 180r from each eye enter the Panum's fusional region 195 in which real object 194 is located. The Panum's fusional region is the area of single vision in a binocular viewing system like that of human vision. The intersection of the gaze vectors 180l and 180r indicates that the wearer is looking at real object 194. At such a distance, as the eyeballs rotate inward, the distance between their pupils decreases to a near IPD. The near IPD is typically about 4 mm less than the far IPD. A near IPD distance criteria, e.g. a point of gaze at less than four feet for example, may be used to switch or adjust the IPD alignment of the display optical systems 14 to that of the near IPD. For the near IPD, each display optical system 14 may be moved toward the wearer's nose so the optical axis, and detection area 139, moves toward the nose a few millimeters as represented by detection areas 139ln and 139m.

Techniques for automatically determining a wearer's IPD and automatically adjusting the see through head mounted display see through head mounted display to set the IPD for optimal wearer viewing, are discussed in co-pending U.S. patent application Ser. No. 13/221,739 entitled Gaze Detection In A See-Through, Near-Eye, Mixed Reality Display; U.S. patent application Ser. No. 13/221,707 entitled Adjustment Of A Mixed Reality Display For Inter-Pupillary Distance Alignment; and U.S. patent application Ser. No. 13/221,662 entitled Aligning Inter-Pupillary Distance In A Near-Eye Display System, all of which are hereby incorporated specifically by reference.

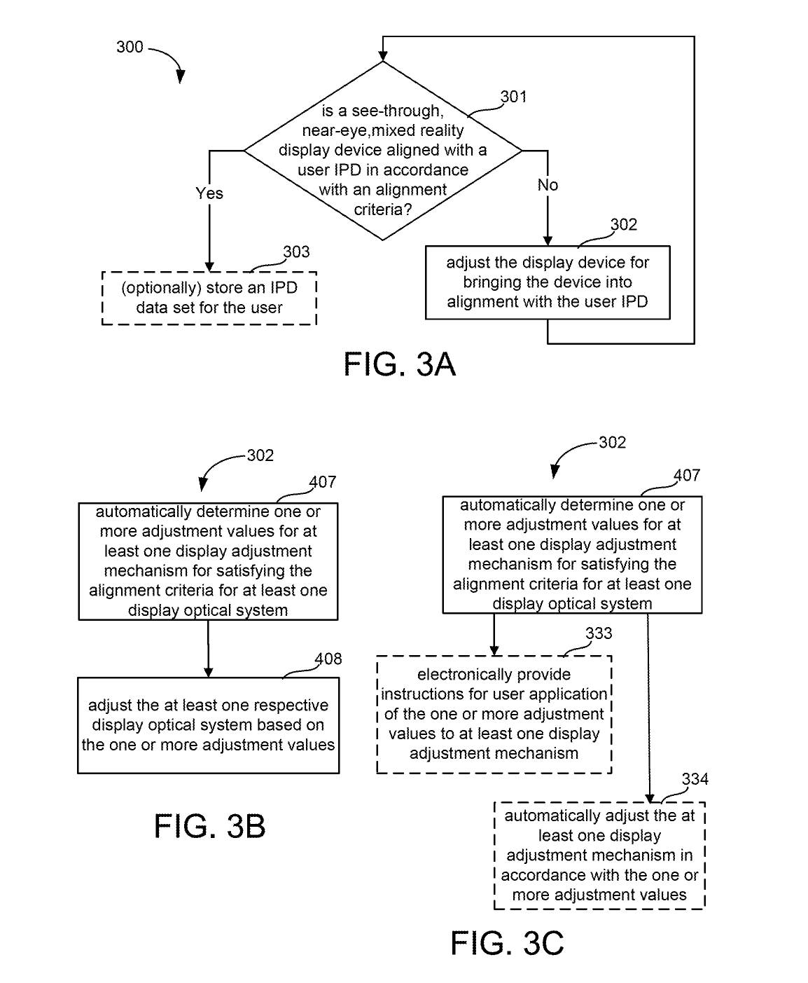

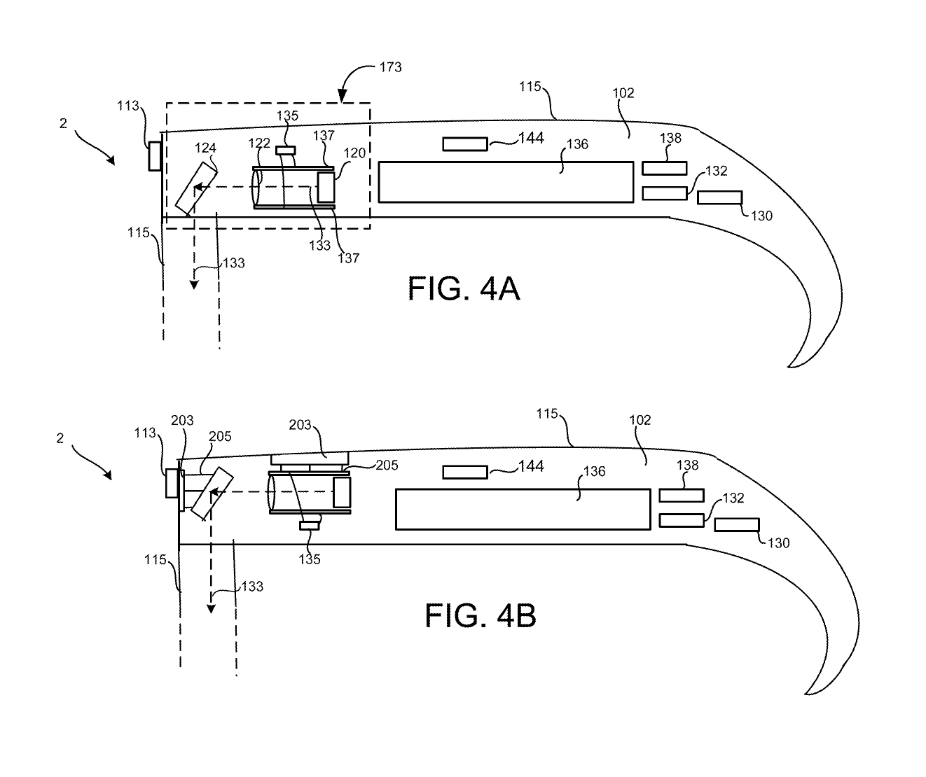

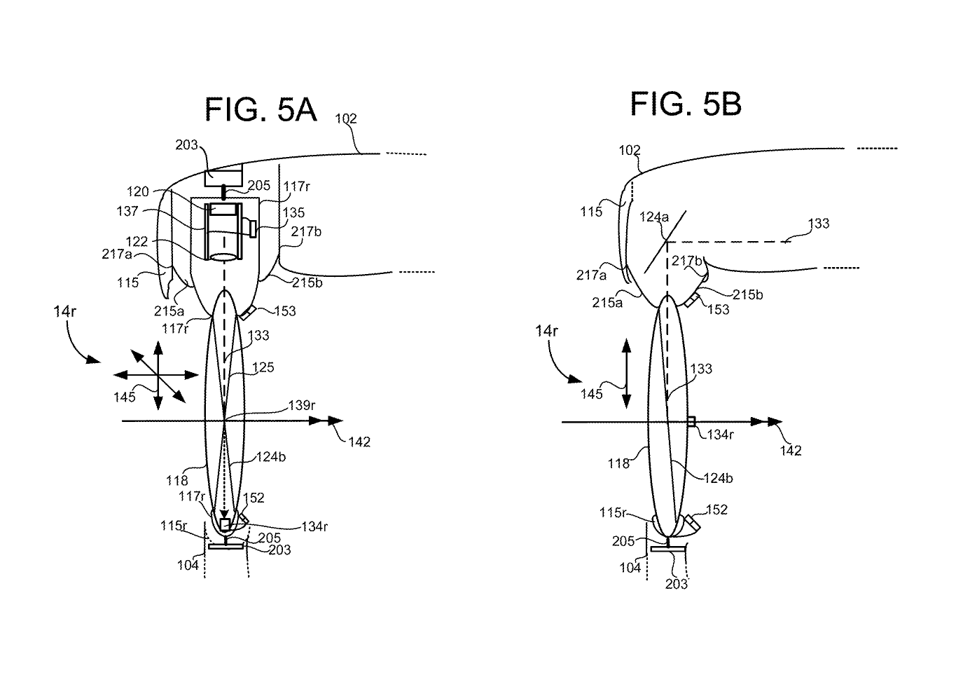

In general, FIG. 3A shows is a flowchart of a method embodiment 300 for aligning a see-through, near-eye, mixed reality display with an IPD. In step 301, one or more processors of the control circuitry 136, e.g. processor 210 in FIG. 7A below, the processing unit 4, 5, the hub computing system 12 or a combination of these automatically determines whether a see-through, near-eye, mixed reality display device is aligned with an IPD of a wearer in accordance with an alignment criteria. If not, in step 302, the one or more processors cause adjustment of the display device by at least one display adjustment mechanism for bringing the device into alignment with the wearer IPD. If it is determined the see-through, near-eye, mixed reality display device is in alignment with a wearer IPD, optionally, in step 303 an IPD data set is stored for the wearer. In some embodiments, a display device 2 may automatically determine whether there is IPD alignment every time anyone puts on the display device 2. However, as IPD data is generally fixed for adults, due to the confines of the human skull, an IPD data set may be determined typically once and stored for each wearer. The stored IPD data set may at least be used as an initial setting for a display device with which to begin an IPD alignment check.

FIG. 3B is a flowchart of an implementation example of a method for adjusting a display device for bringing the device into alignment with a wearer IPD. In this method, at least one display adjustment mechanism adjusts the position of a at least one display optical system 14 which is misaligned. In step 407, one or more adjustment are automatically determined for the at least one display adjustment mechanism for satisfying the alignment criteria for at least one display optical system. In step 408, that at least one display optical system is adjusted based on the one or more adjustment values. The adjustment may be performed automatically under the control of a processor or mechanically as discussed further below.

FIG. 3C is a flowchart illustrating different example options of mechanical or automatic adjustment by the at least one display adjustment mechanism as may be used to implement step 408. Depending on the configuration of the display adjustment mechanism in the display device 2, from step 407 in which the one or more adjustment values were already determined, the display adjustment mechanism may either automatically, meaning under the control of a processor, adjust the at least one display adjustment mechanism in accordance with the one or more adjustment values in step 334. Alternatively, one or more processors associated with the system, e.g. a processor in processing unit 4,5, processor 210 in the control circuitry 136, or even a processor of hub computing system 12 may electronically provide instructions as per step 333 for wearer application of the one or more adjustment values to the at least one display adjustment mechanism. There may be instances of a combination of automatic and mechanical adjustment under instructions.

Some examples of electronically provided instructions are instructions displayed by the microdisplay 120, the mobile device 5 or on a display 16 by the hub computing system 12 or audio instructions through speakers 130 of the display device 2. There may be device configurations with an automatic adjustment and a mechanical mechanism depending on wearer preference or for allowing a wearer some additional control.

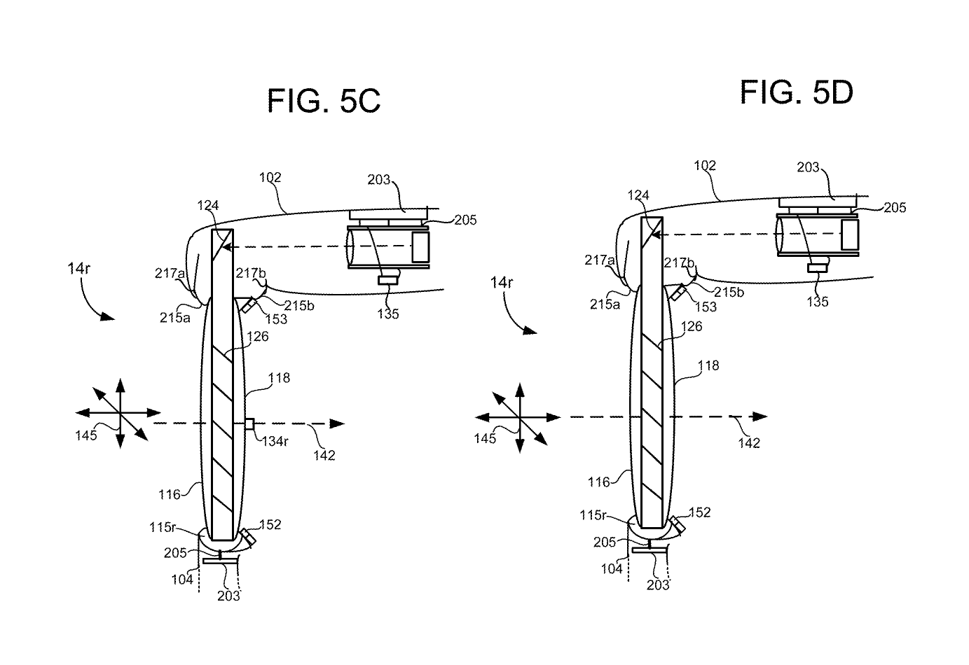

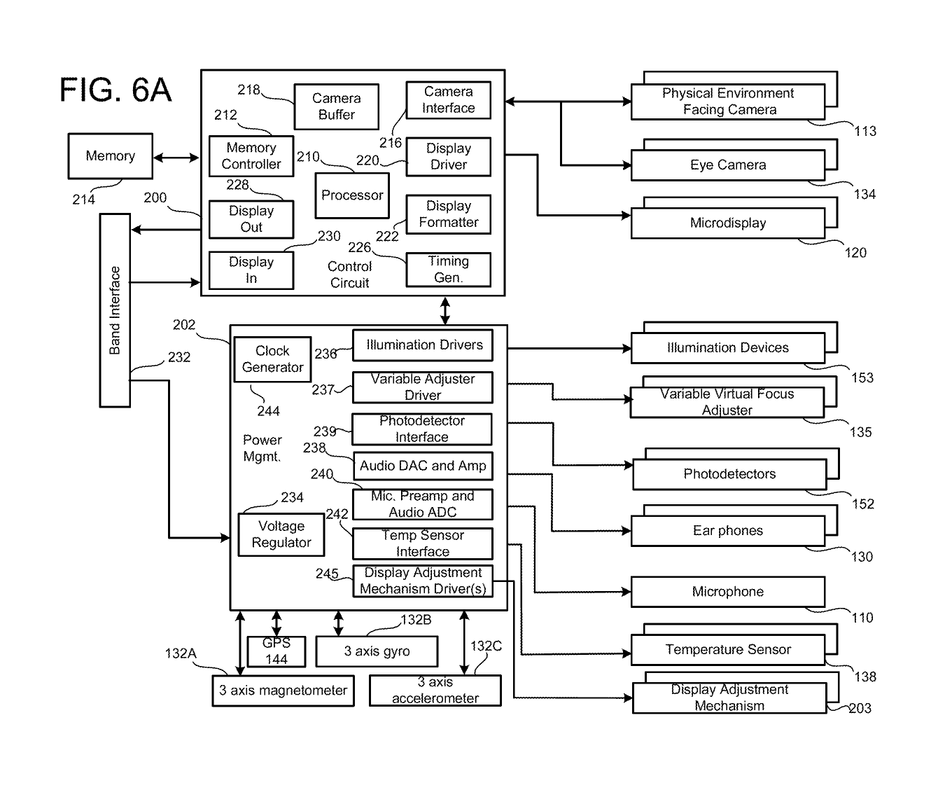

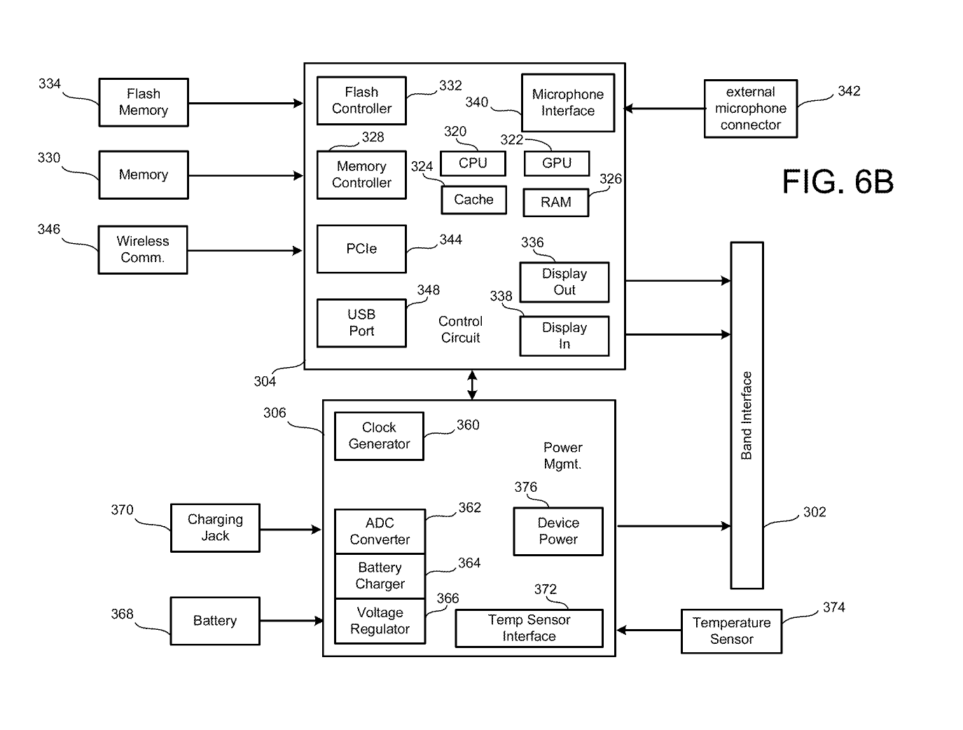

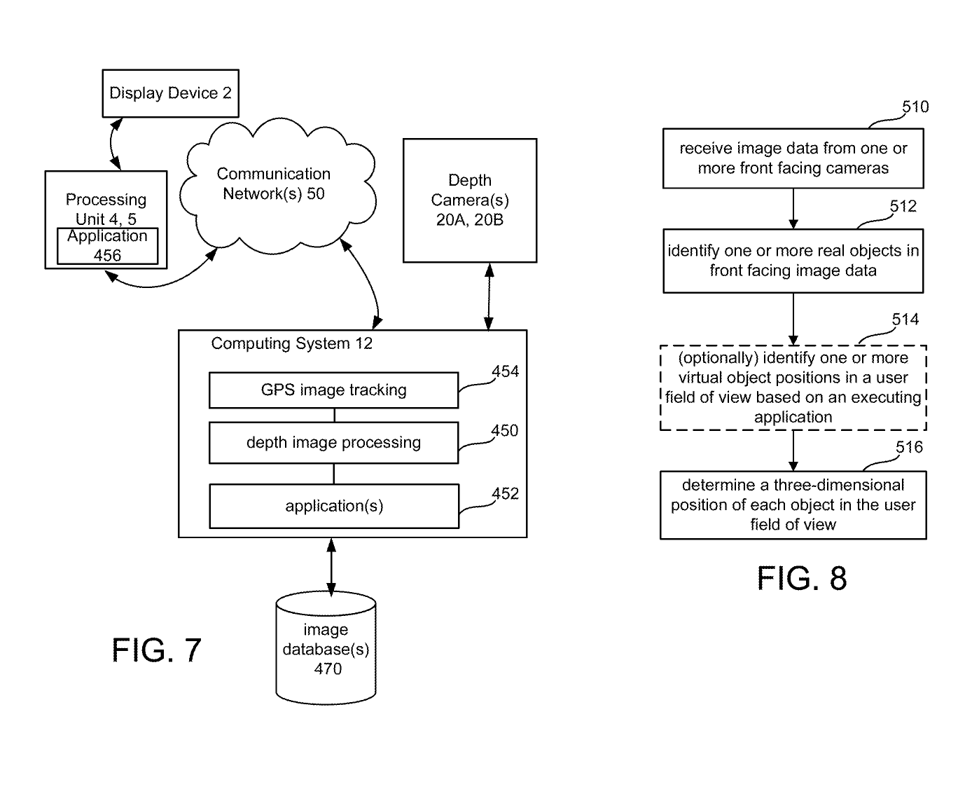

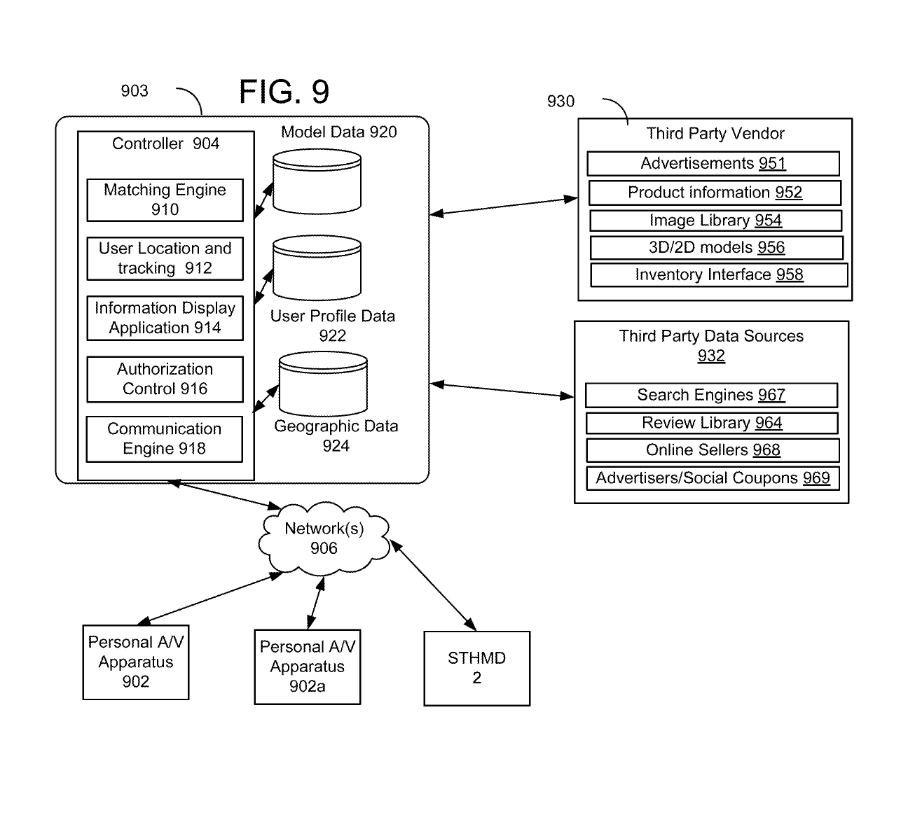

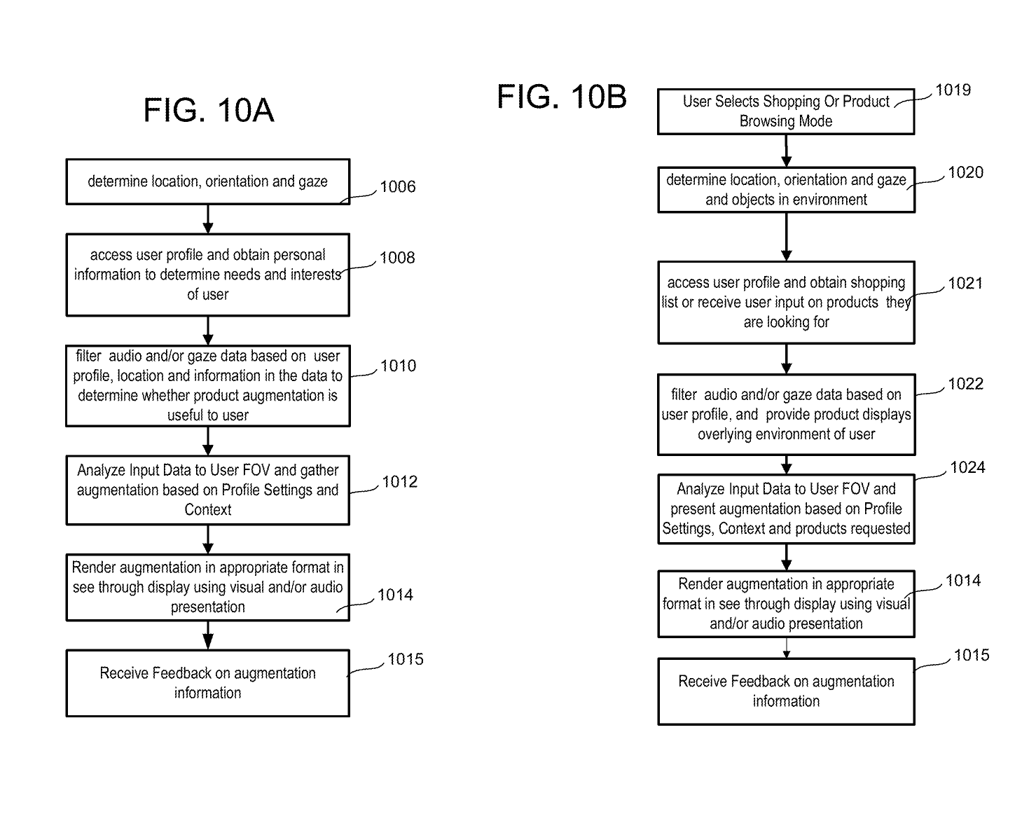

FIG. 4A illustrates an exemplary arrangement of a see through, near-eye, mixed reality display device embodied as eyeglasses with movable display optical systems including gaze detection elements. What appears as a lens for each eye represents a display optical system 14 for each eye, e.g. 14r and 14l. A display optical system includes a see-through lens, e.g. 118 and 116 in FIGS. 5A-5b, as in an ordinary pair of glasses, but also contains optical elements (e.g. mirrors, filters) for seamlessly fusing virtual content with the actual direct real world view seen through the lenses 118, 116. A display optical system 14 has an optical axis which is generally in the center of the see-through lens 118, 116 in which light is generally collimated to provide a distortionless view. For example, when an eye care professional fits an ordinary pair of eyeglasses to a wearer's face, a goal is that the glasses sit on the wearer's nose at a position where each pupil is aligned with the center or optical axis of the respective lens resulting in generally collimated light reaching the wearer's eye for a clear or distortionless view.

In an exemplary device 2, a detection area of at least one sensor is aligned with the optical axis of its respective display optical system so that the center of the detection area is capturing light along the optical axis. If the display optical system is aligned with the wearer's pupil, each detection area of the respective sensor is aligned with the wearer's pupil. Reflected light of the detection area is transferred via one or more optical elements to the actual image sensor of the camera in this example illustrated by dashed line as being inside the frame 115.

In one example, a visible light camera (also commonly referred to as an RGB camera) may be the sensor. An example of an optical element or light directing element is a visible light reflecting mirror which is partially transmissive and partially reflective. The visible light camera provides image data of the pupil of the wearer's eye, while IR photodetectors 152 capture glints which are reflections in the IR portion of the spectrum. If a visible light camera is used, reflections of virtual images may appear in the eye data captured by the camera. An image filtering technique may be used to remove the virtual image reflections if desired. An IR camera is not sensitive to the virtual image reflections on the eye.

In other examples, the at least one sensor is an IR camera or a position sensitive detector (PSD) to which the IR radiation may be directed. For example, a hot reflecting surface may transmit visible light but reflect IR radiation. The IR radiation reflected from the eye may be from incident radiation of illuminators, other IR illuminators (not shown) or from ambient IR radiation reflected off the eye. In some examples, sensor may be a combination of an RGB and an IR camera, and the light directing elements may include a visible light reflecting or diverting element and an IR radiation reflecting or diverting element. In some examples, a camera may be small, e.g. 2 millimeters (mm) by 2 mm.

Various types of gaze detection systems are suitable for use in the present system. In some embodiments which calculate a cornea center as part of determining a gaze vector, two glints, and therefore two illuminators will suffice. However, other embodiments may use additional glints in determining a pupil position and hence a gaze vector. As eye data representing the glints is repeatedly captured, for example at 30 frames a second or greater, data for one glint may be blocked by an eyelid or even an eyelash, but data may be gathered by a glint generated by another illuminator.

FIG. 4A is a side view of an eyeglass temple 102 of the frame 115 in an eyeglasses embodiment of a see-through, mixed reality display device. At the front of frame 115 is physical environment facing video camera 113 that can capture video and still images. Particularly in some embodiments, physical environment facing camera 113 may be a depth camera as well as a visible light or RGB camera. For example, the depth camera may include an IR illuminator transmitter and a hot reflecting surface like a hot mirror in front of the visible image sensor which lets the visible light pass and directs reflected IR radiation within a wavelength range or about a predetermined wavelength transmitted by the illuminator to a CCD or other type of depth sensor. Other types of visible light camera (RGB camera) and depth cameras can be used. More information about depth cameras can be found in U.S. patent application Ser. No. 12/813,675, filed on Jun. 11, 2010, incorporated herein by reference in its entirety. The data from the sensors may be sent to a processor 210 of the control circuitry 136, or the processing unit 4, 5 or both which may process them but which the unit 4,5 may also send to a computer system over a network or hub computing system 12 for processing. The processing identifies objects through image segmentation and edge detection techniques and maps depth to the objects in the wearer's real world field of view. Additionally, the physical environment facing camera 113 may also include a light meter for measuring ambient light.

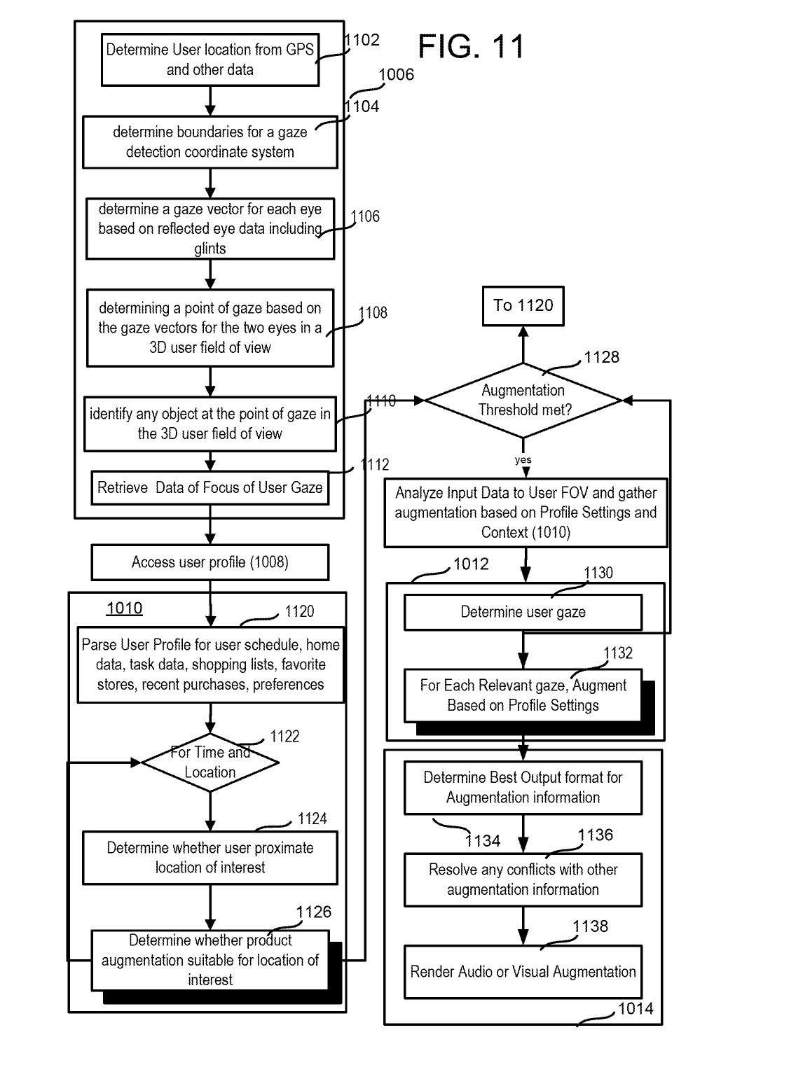

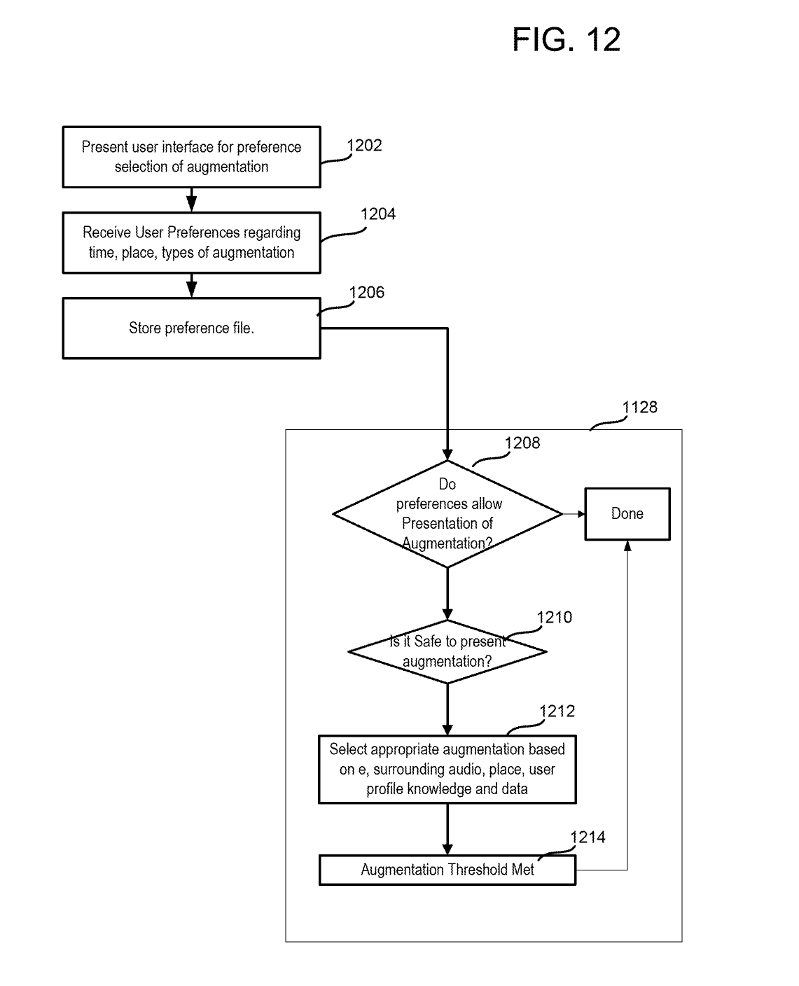

Control circuits 136 provide various electronics that support the other components of head mounted display device 2. More details of control circuits 136 are provided below with respect to FIG. 6A and 6B. Inside, or mounted to temple 102, are ear phones 130, inertial sensors 132, GPS transceiver 144 and temperature sensor 138. In one embodiment inertial sensors 132 include a three axis magnetometer 132A, three axis gyro 132B and three axis accelerometer 132C (See FIG. 7A). The inertial sensors are for sensing position, orientation, and sudden accelerations of head mounted display device 2. From these movements, head position may also be determined.

The display device 2 provides an image generation unit which can create one or more images including one or more virtual objects. In some embodiments a microdisplay may be used as the image generation unit. A microdisplay assembly 173 in this example comprises light processing elements and a variable focus adjuster 135. An example of a light processing element is a microdisplay unit 120. Other examples include one or more optical elements such as one or more lenses of a lens system 122 and one or more reflecting elements such as surfaces 124a and 124b in FIGS. 6A and 6B or 124 in FIGS. 6C and 6D. Lens system 122 may comprise a single lens or a plurality of lenses.

Mounted to or inside temple 102, the microdisplay unit 120 includes an image source and generates an image of a virtual object. The microdisplay unit 120 is optically aligned with the lens system 122 and the reflecting surface 124 or reflecting surfaces 124a and 124b as illustrated in the following Figures. The optical alignment may be along an optical axis 133 or an optical path 133 including one or more optical axes. The microdisplay unit 120 projects the image of the virtual object through lens system 122, which may direct the image light, onto reflecting element 124 which directs the light into lightguide optical element 112 as in FIGS. 5C and 5D or onto reflecting surface 124a (e.g. a mirror or other surface) which directs the light of the virtual image to a partially reflecting element 124b which combines the virtual image view along path 133 with the natural or actual direct view along the optical axis 142 as in FIGS. 5A-5D. The combination of views are directed into a wearer's eye.

The variable focus adjuster 135 changes the displacement between one or more light processing elements in the optical path of the microdisplay assembly or an optical power of an element in the microdisplay assembly. The optical power of a lens is defined as the reciprocal of its focal length, e.g. 1/focal length, so a change in one effects the other. The change in focal length results in a change in the region of the field of view, e.g. a region at a certain distance, which is in focus for an image generated by the microdisplay assembly 173.

In one example of the microdisplay assembly 173 making displacement changes, the displacement changes are guided within an armature 137 supporting at least one light processing element such as the lens system 122 and the microdisplay 120 in this example. The armature 137 helps stabilize the alignment along the optical path 133 during physical movement of the elements to achieve a selected displacement or optical power. In some examples, the adjuster 135 may move one or more optical elements such as a lens in lens system 122 within the armature 137. In other examples, the armature may have grooves or space in the area around a light processing element so it slides over the element, for example, microdisplay 120, without moving the light processing element. Another element in the armature such as the lens system 122 is attached so that the system 122 or a lens within slides or moves with the moving armature 137. The displacement range is typically on the order of a few millimeters (mm). In one example, the range is 1-2 mm. In other examples, the armature 137 may provide support to the lens system 122 for focal adjustment techniques involving adjustment of other physical parameters than displacement. An example of such a parameter is polarization.

For more information on adjusting a focal distance of a microdisplay assembly, see U.S. Pat. No. 12/941,825 entitled “Automatic Variable Virtual Focus for Augmented Reality Displays,” filed Nov. 8, 2010, having inventors Avi Bar-Zeev and John Lewis and which is hereby incorporated by reference.

In one example, the adjuster 135 may be an actuator such as a piezoelectric motor. Other technologies for the actuator may also be used and some examples of such technologies are a voice coil formed of a coil and a permanent magnet, a magnetostriction element, and an electrostriction element.

There are different image generation technologies that can be used to implement microdisplay 120. For example, microdisplay 120 can be implemented using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are all examples of reflective technologies which are efficient as most energy is reflected away from the modulated structure and may be used in the system described herein. Additionally, microdisplay 120 can be implemented using an emissive technology where light is generated by the display. For example, a PicoP™ engine from Microvision, Inc. emits a laser signal with a micro mirror steering either onto a tiny screen that acts as a transmissive element or beamed directly into the eye (e.g., laser).

FIG. 4B is a side view of an eyeglass temple in another embodiment of a mixed reality display device providing support for hardware and software components and three dimensional adjustment of a microdisplay assembly. Some of the numerals illustrated in the FIG. 5A above have been removed to avoid clutter in the drawing. In embodiments where the display optical system 14 is moved in any of three dimensions, the optical elements represented by reflecting surface 124 and the other elements of the microdisplay assembly 173, e.g. 120, 122 may also be moved for maintaining the optical path 133 of the light of a virtual image to the display optical system. An XYZ transport mechanism in this example made up of one or more motors represented by motor block 203 and shafts 205 under control of the processor 210 of control circuitry 136 (see FIG. 6A) control movement of the elements of the microdisplay assembly 173. An example of motors which may be used are piezoelectric motors. In the illustrated example, one motor is attached to the armature 137 and moves the variable focus adjuster 135 as well, and another representative motor 203 controls the movement of the reflecting element 124.

FIG. 5A is a top view of an embodiment of a movable display optical system 14 of a see-through, near-eye, mixed reality device 2 including an arrangement of gaze detection elements. A portion of the frame 115 of the near-eye display device 2 will surround a display optical system 14 and provides support for elements of an embodiment of a microdisplay assembly 173 including microdisplay 120 and its accompanying elements as illustrated. In order to show the components of the display system 14, in this case 14r for the right eye system, a top portion of the frame 115 surrounding the display optical system is not depicted. Additionally, the microphone 110 in bridge 104 is not shown in this view to focus attention on the operation of the display adjustment mechanism 203. As in the example of FIG. 4C, the display optical system 14 in this embodiment is moved by moving an inner frame 117r, which in this example surrounds the microdisplay assembly 173 as well. The display adjustment mechanism is embodied in this embodiment as three axis motors 203 which attach their shafts 205 to inner frame 117r to translate the display optical system 14, which in this embodiment includes the microdisplay assembly 173, in any of three dimensions as denoted by symbol 144 indicating three (3) axes of movement.

The display optical system 14 in this embodiment has an optical axis 142 and includes a see-through lens 118 allowing the wearer an actual direct view of the real world. In this example, the see-through lens 118 is a standard lens used in eye glasses and can be made to any prescription (including no prescription). In another embodiment, see-through lens 118 can be replaced by a variable prescription lens. In some embodiments, see-through, near-eye display device 2 will include additional lenses.

The display optical system 14 further comprises reflecting surfaces 124a and 124b. In this embodiment, light from the microdisplay 120 is directed along optical path 133 via a reflecting element 124a to a partially reflective element 124b embedded in lens 118 which combines the virtual object image view traveling along optical path 133 with the natural or actual direct view along the optical axis 142 so that the combined views are directed into a wearer's eye, right one in this example, at the optical axis, the position with the most collimated light for a clearest view.

A detection area of a light sensor is also part of the display optical system 14r. An optical element 125 embodies the detection area by capturing reflected light from the wearer's eye received along the optical axis 142 and directs the captured light to the sensor 134r, in this example positioned in the lens 118 within the inner frame 117r. As shown, the arrangement allows the detection area 139 of the sensor 134r to have its center aligned with the center of the display optical system 14. For example, if sensor 134r is an image sensor, sensor 134r captures the detection area 139, so an image captured at the image sensor is centered on the optical axis because the detection area 139 is. In one example, sensor 134r is a visible light camera or a combination of RGB/IR camera, and the optical element 125 includes an optical element which reflects visible light reflected from the wearer's eye, for example a partially reflective mirror.

In other embodiments, the sensor 134r is an IR sensitive device such as an IR camera, and the element 125 includes a hot reflecting surface which lets visible light pass through it and reflects IR radiation to the sensor 134r. An IR camera may capture not only glints, but also an infra-red or near infra-red image of the wearer's eye including the pupil.

In other embodiments, the IR sensor device 134r is a position sensitive device (PSD), sometimes referred to as an optical position sensor. The depiction of the light directing elements, in this case reflecting elements, 125, 124, 124a and 124b in FIGS. 5A-5D are representative of their functions. The elements may take any number of forms and be implemented with one or more optical components in one or more arrangements for directing light to its intended destination such as a camera sensor or a wearer's eye.

As discussed in FIGS. 2A and 2B above and in the Figures below, when the wearer is looking straight ahead, and the center of the wearer's pupil is centered in an image captured of the wearer's eye when a detection area 139 or an image sensor 134r is effectively centered on the optical axis of the display, the display optical system 14r is aligned with the pupil. When both display optical systems 14 are aligned with their respective pupils, the distance between the optical centers matches or is aligned with the wearer's inter-pupillary distance. In the example of FIG. 6A, the inter-pupillary distance can be aligned with the display optical systems 14 in three dimensions.

In one embodiment, if the data captured by the sensor 134 indicates the pupil is not aligned with the optical axis, one or more processors in the processing unit 4, 5 or the control circuitry 136 or both use a mapping criteria which correlates a distance or length measurement unit to a pixel or other discrete unit or area of the image for determining how far off the center of the pupil is from the optical axis 142. Based on the distance determined, the one or more processors determine adjustments of how much distance and in which direction the display optical system 14r is to be moved to align the optical axis 142 with the pupil. Control signals are applied by one or more display adjustment mechanism drivers 245 to each of the components, e.g. motors 203, making up one or more display adjustment mechanisms 203. In the case of motors in this example, the motors move their shafts 205 to move the inner frame 117r in at least one direction indicated by the control signals. On the temple side of the inner frame 117r are flexible sections 215a, 215b of the frame 115 which are attached to the inner frame 117r at one end and slide within grooves 217a and 217b within the interior of the temple frame 115 to anchor the inner frame 117 to the frame 115 as the display optical system 14 is move in any of three directions for width, height or depth changes with respect to the respective pupil.

In addition to the sensor, the display optical system 14 includes other gaze detection elements. In this embodiment, attached to frame 117r on the sides of lens 118, are at least two (2) but may be more, infra-red (IR) illuminating devices 153 which direct narrow infra-red light beams within a particular wavelength range or about a predetermined wavelength at the wearer's eye to each generate a respective glint on a surface of the respective cornea. In other embodiments, the illuminators and any photodiodes may be on the lenses, for example at the corners or edges. In this embodiment, in addition to the at least 2 infra-red (IR) illuminating devices 153 are IR photodetectors 152. Each photodetector 152 is sensitive to IR radiation within the particular wavelength range of its corresponding IR illuminator 153 across the lens 118 and is positioned to detect a respective glint. As shown in FIGS. 4A-4C, the illuminator and photodetector are separated by a barrier 154 so that incident IR light from the illuminator 153 does not interfere with reflected IR light being received at the photodetector 152. In the case where the sensor 134 is an IR sensor, the photodetectors 152 may not be needed or may be an additional glint data capture source. With a visible light camera, the photodetectors 152 capture light from glints and generate glint intensity values.

In FIGS. 5A-5D, the positions of the gaze detection elements, e.g. the detection area 139 and the illuminators 153 and photodetectors 152 are fixed with respect to the optical axis of the display optical system 14. These elements may move with the display optical system 14r, and hence its optical axis, on the inner frame, but their spatial relationship to the optical axis 142 does not change.

FIG. 5B is a top view of another embodiment of a movable display optical system of a see-through, near-eye, mixed reality device including an arrangement of gaze detection elements. In this embodiment, light sensor 134r may be embodied as a visible light camera, sometimes referred to as an RGB camera, or it may be embodied as an IR camera or a camera capable of processing light in both the visible and IR ranges, e.g. a depth camera. In this example, the image sensor 134r is the detection area 139r. The image sensor 134 of the camera is located vertically on the optical axis 142 of the display optical system. In some examples, the camera may be located on frame 115 either above or below see-through lens 118 or embedded in the lens 118. In some embodiments, the illuminators 153 provide light for the camera, and in other embodiments the camera captures images with ambient lighting or light from its own light source. Image data captured may be used to determine alignment of the pupil with the optical axis. Gaze determination techniques based on image data, glint data or both may be used based on the geometry of the gaze detection elements.

In this example, the motor 203 in bridge 104 moves the display optical system 14r in a horizontal direction with respect to the wearer's eye as indicated by directional symbol 145. The flexible frame portions 215a and 215b slide within grooves 217a and 217b as the system 14 is moved. In this example, reflecting element 124a of an microdisplay assembly 173 embodiment is stationery. As the IPD is typically determined once and stored, any adjustment of the focal length between the microdisplay 120 and the reflecting element 124a that may be done may be accomplished by the microdisplay assembly, for example via adjustment of the microdisplay elements within the armature 137.

FIG. 5C is a top view of a third embodiment of a movable display optical system of a see-through, near-eye, mixed reality device including an arrangement of gaze detection elements. The display optical system 14 has a similar arrangement of gaze detection elements including IR illuminators 153 and photodetectors 152, and a light sensor 134r located on the frame 115 or lens 118 below or above optical axis 142. In this example, the display optical system 14 includes a light guide optical element 112 as the reflective element for directing the images into the wearer's eye and is situated between an additional see-through lens 116 and see-through lens 118. As reflecting element 124 is within the lightguide optical element and moves with the element 112, an embodiment of a microdisplay assembly 173 is attached on the temple 102 in this example to a display adjustment mechanism 203 for the display optical system 14 embodied as a set of three axis motor 203 with shafts 205 include at least one for moving the microdisplay assembly. One or more motors 203 on the bridge 104 are representative of the other components of the display adjustment mechanism 203 which provides three axes of movement 145. In another embodiment, the motors may operate to only move the devices via their attached shafts 205 in the horizontal direction. The motor 203 for the microdisplay assembly 173 would also move it horizontally for maintaining alignment between the light coming out of the microdisplay 120 and the reflecting element 124. A processor 210 of the control circuitry (see FIG. 7A) coordinates their movement.

Lightguide optical element 112 transmits light from microdisplay 120 to the eye of the wearer wearing head mounted display device 2. Lightguide optical element 112 also allows light from in front of the head mounted display device 2 to be transmitted through lightguide optical element 112 to the wearer's eye thereby allowing the wearer to have an actual direct view of the space in front of head mounted display device 2 in addition to receiving a virtual image from microdisplay 120. Thus, the walls of lightguide optical element 112 are see-through. Lightguide optical element 112 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar, substrate comprising lightguide optical element 112 by internal reflection.

After several reflections off the surfaces of the substrate, the trapped light waves reach an array of selectively reflecting surfaces 126. Note that only one of the five surfaces is labeled 126 to prevent over-crowding of the drawing. Reflecting surfaces 126 couple the light waves incident upon those reflecting surfaces out of the substrate into the eye of the wearer. More details of a lightguide optical element can be found in United States Patent Application Publication 2008/0285140, Ser. No. 12/214,366, published on Nov. 20, 2008, “Substrate-Guided Optical Devices” incorporated herein by reference in its entirety. In one embodiment, each eye will have its own lightguide optical element 112.

FIG. 5D is a top view of a fourth embodiment of a movable display optical system of a see-through, near-eye, mixed reality device including an arrangement of gaze detection elements. This embodiment is similar to FIG. 5C's embodiment including a light guide optical element 112. However, the only light detectors are the IR photodetectors 152, so this embodiment relies on glint detection only for gaze detection as discussed in the examples below.

In the embodiments of FIGS. 5A-5D, the positions of the gaze detection elements, e.g. the detection area 139 and the illuminators 153 and photodetectors 152 are fixed with respect to each other. In these examples, they are also fixed in relation to the optical axis of the display optical system 14.

In the embodiments above, the specific number of lenses shown are just examples. Other numbers and configurations of lenses operating on the same principles may be used. Additionally, in the examples above, only the right side of the see-through, near-eye display 2 are shown. A full near-eye, mixed reality display device would include as examples another set of lenses 116 and/or 118, another lightguide optical element 112 for the embodiments of FIGS. 5C and 5D, another micro display 120, another lens system 122, likely another environment facing camera 113, another eye tracking camera 134 for the embodiments of FIGS. 6A to 6C, earphones 130, and a temperature sensor 138.

FIG. 6A is a block diagram of one embodiment of hardware and software components of a see-through, near-eye, mixed reality display unit 2 as may be used with one or more embodiments. FIG. 7B is a block diagram describing the various components of a processing unit 4, 5. In this embodiment, near-eye display device 2, receives instructions about a virtual image from processing unit 4, 5 and provides the sensor information back to processing unit 4, 5. Software and hardware components which may be embodied in a processing unit 4, 5 are depicted in FIG. 6B, will receive the sensory information from the display device 2 and may also receive sensory information from hub computing device 12 (See FIG. 1A). Based on that information, processing unit 4, 5 will determine where and when to provide a virtual image to the wearer and send instructions accordingly to the control circuitry 136 of the display device 2.

Note that some of the components of FIG. 6A (e.g., physical environment facing camera 113, eye camera 134, variable virtual focus adjuster 135, photodetector interface 139, micro display 120, illumination device 153 or illuminators, earphones 130, temperature sensor 138, display adjustment mechanism 203) are shown in shadow to indicate that there are at least two of each of those devices, at least one for the left side and at least one for the right side of head mounted display device 2. FIG. 6A shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230. In one embodiment, all of components of control circuit 220 are in communication with each other via dedicated lines of one or more buses. In another embodiment, each of the components of control circuit 200 are in communication with processor 210.

Camera interface 216 provides an interface to the two physical environment facing cameras 113 and each eye camera 134 and stores respective images received from the cameras 113, 134 in camera buffer 218. Display driver 220 will drive microdisplay 120. Display formatter 222 may provide information, about the virtual image being displayed on microdisplay 120 to one or more processors of one or more computer systems, e.g. 4, 5, 12, 210 performing processing for the augmented reality system. Timing generator 226 is used to provide timing data for the system. Display out 228 is a buffer for providing images from physical environment facing cameras 113 and the eye cameras 134 to the processing unit 4, 5. Display in 230 is a buffer for receiving images such as a virtual image to be displayed on microdisplay 120. Display out 228 and display in 230 communicate with band interface 232 which is an interface to processing unit 4, 5.

Power management circuit 202 includes voltage regulator 234, eye tracking illumination driver 236, variable adjuster driver 237, photodetector interface 239, audio DAC and amplifier 238, microphone preamplifier and audio ADC 240, temperature sensor interface 242, display adjustment mechanism driver(s) 245 and clock generator 244. Voltage regulator 234 receives power from processing unit 4, 5 via band interface 232 and provides that power to the other components of head mounted display device 2. Illumination driver 236 controls, for example via a drive current or voltage, the illumination devices 153 to operate about a predetermined wavelength or within a wavelength range. Audio DAC and amplifier 238 receives the audio information from earphones 130. Microphone preamplifier and audio ADC 240 provides an interface for microphone 110. Temperature sensor interface 242 is an interface for temperature sensor 138. One or more display adjustment drivers 245 provide control signals to one or more motors or other devices making up each display adjustment mechanism 203 which represent adjustment amounts of movement in at least one of three directions. Power management unit 202 also provides power and receives data back from three axis magnetometer 132A, three axis gyro 132B and three axis accelerometer 132C. Power management unit 202 also provides power and receives data back from and sends data to GPS transceiver 144.

The variable adjuster driver 237 provides a control signal, for example a drive current or a drive voltage, to the adjuster 135 to move one or more elements of the microdisplay assembly 173 to achieve a displacement for a focal region calculated by software executing in a processor 210 of the control circuitry 13, or the processing unit 4,5 or the hub computer 12 or both. In embodiments of sweeping through a range of displacements and, hence, a range of focal regions, the variable adjuster driver 237 receives timing signals from the timing generator 226, or alternatively, the clock generator 244 to operate at a programmed rate or frequency.

The photodetector interface 239 performs any analog to digital conversion needed for voltage or current readings from each photodetector, stores the readings in a processor readable format in memory via the memory controller 212, and monitors the operation parameters of the photodetectors 152 such as temperature and wavelength accuracy.

FIG. 6B is a block diagram of one embodiment of the hardware and software components of a processing unit 4 associated with a see-through, near-eye, mixed reality display unit. The mobile device 5 may include this embodiment of hardware and software components as well as similar components which perform similar functions. FIG. 6B shows controls circuit 304 in communication with power management circuit 306. Control circuit 304 includes a central processing unit (CPU) 320, graphics processing unit (GPU) 322, cache 324, RAM 326, memory control 328 in communication with memory 330 (e.g., D-RAM), flash memory controller 332 in communication with flash memory 334 (or other type of non-volatile storage), display out buffer 336 in communication with see-through, near-eye display device 2 via band interface 302 and band interface 232, display in buffer 338 in communication with near-eye display device 2 via band interface 302 and band interface 232, microphone interface 340 in communication with an external microphone connector 342 for connecting to a microphone, PCI express interface for connecting to a wireless communication device 346, and USB port(s) 348.

In one embodiment, wireless communication component 346 can include a Wi-Fi enabled communication device, Bluetooth communication device, infrared communication device, etc. The USB port can be used to dock the processing unit 4, 5 to hub computing device 12 in order to load data or software onto processing unit 4, 5, as well as charge processing unit 4, 5. In one embodiment, CPU 320 and GPU 322 are the main workhorses for determining where, when and how to insert images into the view of the wearer.

Power management circuit 306 includes clock generator 360, analog to digital converter 362, battery charger 364, voltage regulator 366, see-through, near-eye display power source 376, and temperature sensor interface 372 in communication with temperature sensor 374 (located on the wrist band of processing unit 4). An alternating current to direct current converter 362 is connected to a charging jack 370 for receiving an AC supply and creating a DC supply for the system. Voltage regulator 366 is in communication with battery 368 for supplying power to the system. Battery charger 364 is used to charge battery 368 (via voltage regulator 366) upon receiving power from charging jack 370. Device power interface 376 provides power to the display device 2.

The Figures above provide examples of geometries of elements for a display optical system which provide a basis for different methods of aligning an IPD as discussed in the following Figures. The method embodiments may refer to elements of the systems and structures above for illustrative context; however, the method embodiments may operate in system or structural embodiments other than those described above.

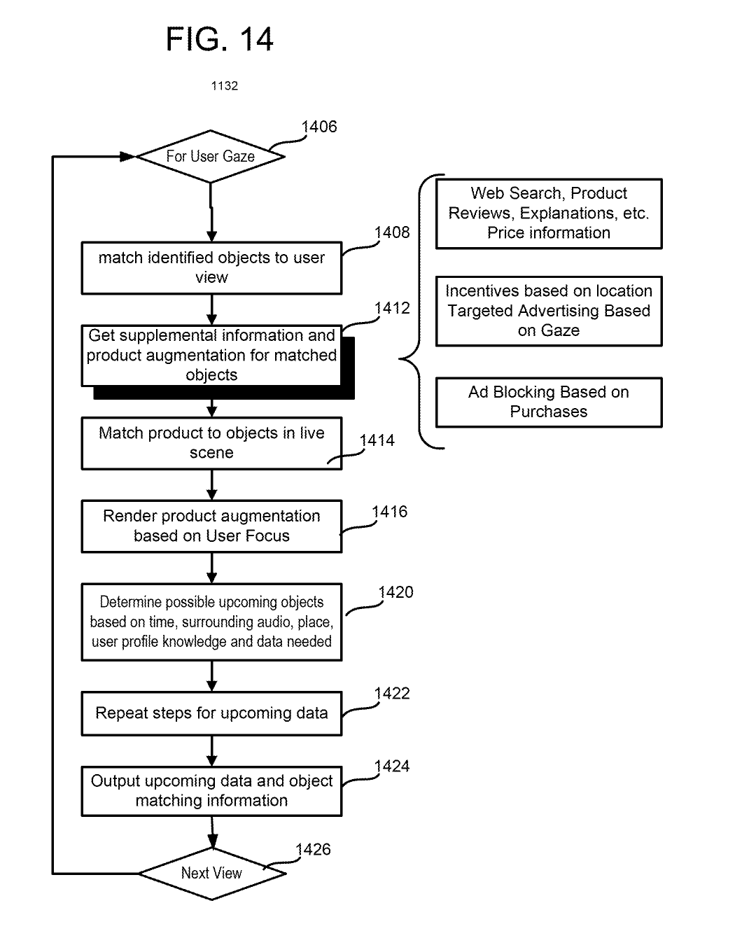

The method embodiments below identify or provide one or more objects of focus for aligning an IPD. FIGS. 8A and 8B discuss some embodiments for determining positions of objects within a field of view of a wearer wearing the display device.

FIG. 7 is a block diagram of a system embodiment for determining positions of objects within a wearer field of view of a see-through, near-eye, mixed reality display device. This embodiment illustrates how the various devices may leverage networked computers to map a three-dimensional model of a wearer field of view and the real and virtual objects within the model. An application 456 executing in a processing unit 4,5 communicatively coupled to a display device 2 can communicate over one or more communication networks 50 with a computing system 12 for processing of image data to determine and track a wearer field of view in three dimensions. The computing system 12 may be executing an application 452 remotely for the processing unit 4,5 for providing images of one or more virtual objects. As mentioned above, in some embodiments, the software and hardware components of the processing unit are integrated into the display device 2. Either or both of the applications 456 and 452 working together may map a 3D model of space around the wearer. A depth image processing application 450 detects objects, identifies objects and their locations in the model. The application 450 may perform its processing based on depth image data from depth camera such as cameras 20A and 20B, two-dimensional or depth image data from one or more front facing cameras 113, and GPS metadata associated with objects in the image data obtained from a GPS image tracking application 454.

The GPS image tracking application 454 identifies images of the wearer's location in one or more image database(s) 470 based on GPS data received from the processing unit 4,5 or other GPS units identified as being within a vicinity of the wearer, or both. Additionally, the image database(s) may provide accessible images of a location with metadata like GPS data and identifying data uploaded by wearer's who wish to share their images. The GPS image tracking application provides distances between objects in an image based on GPS data to the depth image processing application 450. Additionally, the application 456 may perform processing for mapping and locating objects in a 3D wearer space locally and may interact with the GPS image tracking application 454 for receiving distances between objects. Many combinations of shared processing are possible between the applications by leveraging network connectivity.

FIG. 8 is a flowchart of a method embodiment for determining a three-dimensional wearer field of view of a see-through, near-eye, mixed reality display device. In step 510, one or more processors of the control circuitry 136, the processing unit 4,5, the hub computing system 12 or a combination of these receive image data from one or more front facing cameras 113, and in step 512 identify one or more real objects in front facing image data. Based on the position of the front facing camera 113 or a front facing camera 113 for each display optical system, the image data from the front facing camera approximates the wearer field of view. The data from two cameras 113 may be aligned and offsets for the positions of the front facing cameras 113 with respect to the display optical axes accounted for. Data from the orientation sensor 132, e.g. the three axis accelerometer 132C and the three axis magnetometer 132A, can also be used with the front facing camera 113 image data for mapping what is around the wearer,t he position of the wearer's face and head in order to determine which objects, real or virtual, he or she is likely focusing on at the time. Optionally, based on an executing application, the one or more processors in step 514 identify virtual object positions in a wearer field of view which may be determined to be the field of view captured in the front facing image data. In step 516, a three-dimensional position is determined for each object in the wearer field of view. In other words, where each object is located with respect to the display device 2, for example with respect to the optical axis 142 of each display optical system 14.

In some examples for identifying one or more real objects in the front facing image data, GPS data via a GPS unit, e.g. GPS unit 965 in the mobile device 5 or GPS transceiver 144 on the display device 2 may identify the location of the wearer. This location may be communicated over a network from the device 2 or via the processing unit 4,5 to a computer system 12 having access to a database of images 470 which may be accessed based on the GPS data. Based on pattern recognition of objects in the front facing image data and images of the location, the one or more processors determines a relative position of one or more objects in the front facing image data to one or more GPS tracked objects in the location. A position of the wearer from the one or more real objects is determined based on the one or more relative positions.

In other examples, each front facing camera is a depth camera providing depth image data or has a depth sensor for providing depth data which can be combined with image data to provide depth image data. The one or more processors of the control circuitry, e.g. 210, and the processing unit 4,5 identify one or more real objects including their three-dimensional positions in a wearer field of view based on the depth image data from the front facing cameras. Additionally, orientation sensor 132 data may also be used to refine which image data currently represents the wearer field of view. Additionally, a remote computer system 12 may also provide additional processing power to the other processors for identifying the objects and mapping the wearer field of view based on depth image data from the front facing image data.

In other examples, a wearer wearing the display device may be in an environment in which a computer system with depth cameras, like the example of the hub computing system 12 with depth cameras 20A and 20B in system 10 in FIG. 1A, maps in three-dimensions the environment or space and tracks real and virtual objects in the space based on the depth image data from its cameras and an executing application. For example, when a wearer enters a store, a store computer system may map the three-dimensional space. Depth images from multiple perspectives, include depth images from one or more display devices in some examples, may be combined by a depth image processing application 450 based on a common coordinate system for the space. Objects are detected, e.g. edge detection, in the space, and identified by pattern recognition techniques including facial recognition techniques with reference images of things and people from image databases. Such a system can send data such as the position of the wearer within the space and positions of objects around the wearer which the one or more processors of the device 2 and the processing unit 4,5 may use in detecting and identifying which objects are in the wearer field of view. Furthermore, the one or more processors of the display device 2 or the processing unit 4,5 may send the front facing image data and orientation data to the computer system 12 which performs the object detection, identification and object position tracking within the wearer field of view and sends updates to the processing unit 4,5.

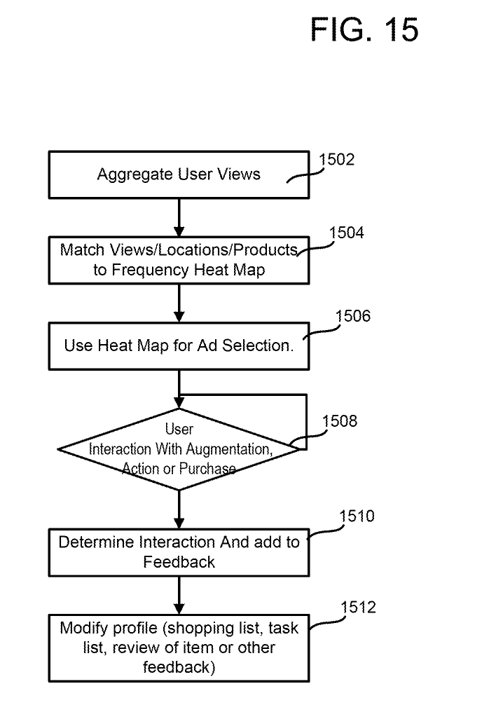

FIG. 9 shows an example of a system architecture for one or more processes and/or software for providing augmentation information to a wearer from a supplemental information provider running on Supplemental Information Provider 903. Supplemental Information Provider 903 may create and provide augmentation data, transmit augmentation data provided by others, store wearer profile information used to provide the augmentation data intelligently, and/or may provide services which transmit event or location data from third party data providers 930 or third party data sources 932 to a wearer's personal A/V apparatus 902. Multiple supplemental information providers and third party event data providers may be utilized with the present technology. A supplemental information provider 903 may include one or more of data storage for a wearer's profile information 922, a wearer's home layout and model data 920 and wearer location historical geographic data 924. The supplemental information provider 903 includes a controller 904 which has functional components including an augmentation matching engine 910, wearer location and tracking data 912, information display applications 914, and an authorization component 916 and a communication engine 918.

It should be understood that the supplemental information provider 903 may comprise any one or more of the processing devices described herein, or a plurality of processing devices coupled via one or more public and private networks 906 to wearers having person audio/visual apparatuses 902, 902a which may include one or more see through head mounted displays 2.

Supplemental Information Provider 903 can collect data from different sources to provide augmentation data to a wearer who accepts information from the provider. In one embodiment, a wearer will register with the system and agree to provide the Provider 903 with wearer profile information to enable intelligent augmentation of information by the Provider 903. User profile information may include, for example, an inventory of objects in the wearer's home, wearer shopping lists, wearer task lists, wearer purchase history, wearer reviews of products purchased, and other information which can be used to provide augmentation information to the wearer. User location and tracking module 912 keeps track of various wearers which are utilizing the system. Users can be identified by unique wearer identifiers, location and other elements. It can also keep a record of retail establishments that a wearer has visited and locations that a wearer is close to. An information display application 914 allows customization of both the type of display information to be provided to wearer's and the manner in which it is displayed. The information display application 914 can be utilized in conjunction with an information display application on the personal A/V apparatus 902. In one embodiment, the display processing occurs at the Supplemental Information Provider 904. In alternative embodiments, information is provided to personal A/V apparatus 902 so that personal A/V apparatus 902 determines which information should be displayed and where, within the display, the information should be located. Third party supplemental information providers 930. 932 can provide various types of data for various types of events, as discussed herein.

Various types of information display applications can be utilized in accordance with the present technology. Different applications can be provided for different events and locations. Different providers may provide different applications for the same live event. Applications may be segregated based on the amount of information provided, the amount of interaction allowed or other feature. Applications can provide different types of experiences within the event or location, and different applications can compete for the ability to provide information to wearer's during the same event or at the same location. Application processing can be split between the application on the supplemental information providers 904 and on the personal A/V apparatus 902.

Three dimensional model data 920 can include one or more virtual three dimensional models of wearer homes and other locations frequented by wearer's with devices 2 or apparatus 902.

Third-party vendors 930 may comprise manufacturers or sellers of goods and products who desire to provide or interact with supplemental information provider 903 to provide augmentation information to wearer's of personal A/V apparatuses. Third-party vendors 930 may provide or allow supplemental information providers access to specific product information 952, image libraries of products 954, 3D and 2D models of products 956, and real or static inventory data 958. Utilizing this third-party vendor information, the supplemental information provider 903 can augment the view of a wearer of a see through head mounted display 2 based on the location and gaze of the wearer to provide additional information about objects or products the wearer is looking at. In addition, the supplemental information provider can provide specific targeted advertising from the third-party vendor or other data services. Third-party data sources 932 may comprise any data source which is useful to provide augmented information to wearer s. This can include Internet search engine data 962, libraries of product reviews 964, information from private online sellers 966, and advertisers 968. Third-party vendors may include advertising data 951 as well.

It will be understood that many other system level architectures may be suitable for use with the present technology.

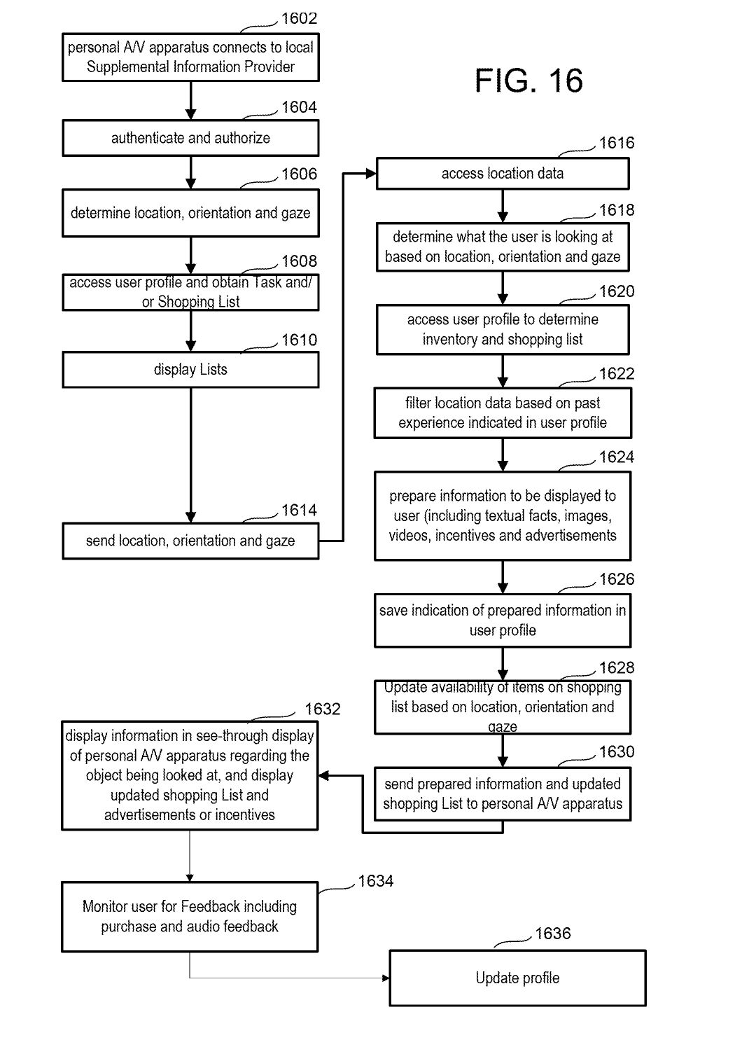

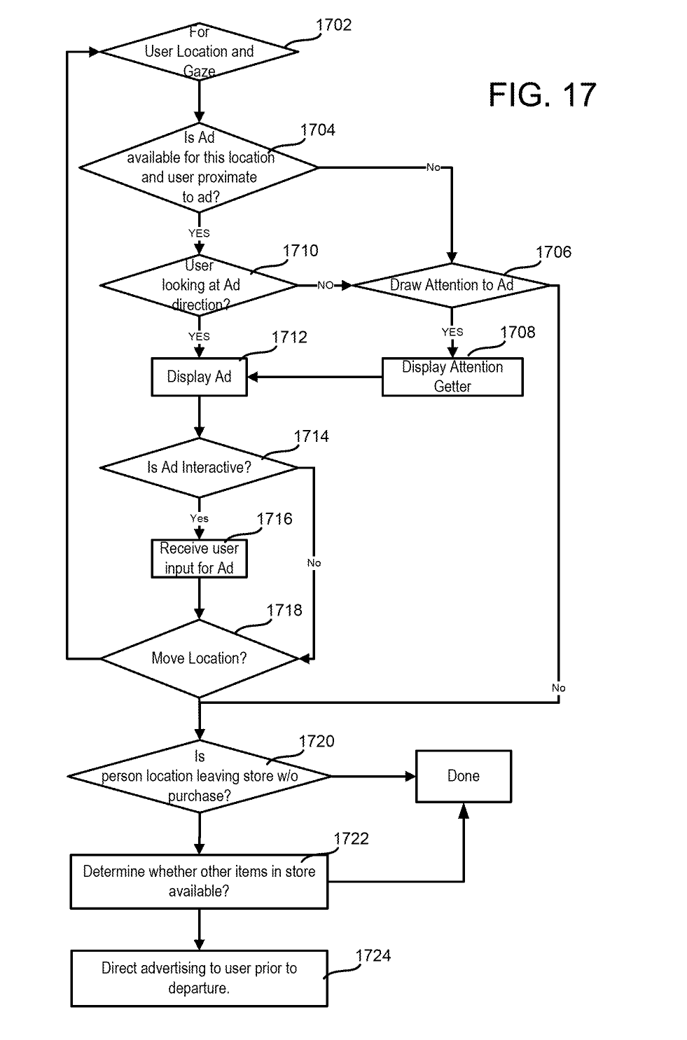

FIGS. 10A and 10B represent two flow charts of an overall method for presenting augmentation information regarding objects in a wearer's view in a see-through head-mounted display or a personal audiovisual apparatus in accordance with the present technology. FIG. 10A represents a method whereby the technology automatically determines whether to present augmentation information based on the wearer profile and the wearer's location. FIG. 10B represents an alternative method where a wearer manually commands the technology to retrieve augmentation information based on a specific command requesting system to provide the information.

In one context, augmentation information comprises information regarding products and services that a wearer is in possession of or needs to acquire. In this context, the augmentation information may comprise product details, reviews of other purchasers or from commercial services, shopping information including pricing and price comparison information, and advertising and incentives on produces and services.

In one embodiment, as represented in FIG. 10A, a wearer of a display device, such as display device 2 represented above with respect to the above figures and accessing a supplemental information provider 903, will be provided with augmentation information in accordance with the method by first determining the location, orientation, and gaze of the wearer at step 1006. The method of FIG. 10A can be performed by the supplemental information provider application in conjunction with the display device 2. Elements of the steps illustrated in FIG. 10A can be provided and performed by the processing unit 4, the display device 2, alone or in conjunction with the supplemental information provider 903. After determining the location, orientation, and gaze of the wearer at 1006, at 1008, the wearer's profile is accessed, and personal information is obtained to determine the needs and interests of the wearer. Depending on where the wearer is and what the wearer may be looking at, augmentation information which is tailored to the elements of the wearer profile which are known can be provided. For example, if the wearer is in a grocery store and has a grocery shopping list stored in his wearer profile, the display device 2 can help guide the wearer through the shopping list, pointing him to different elements on the list and providing information about which items might be on sale in the store.

At 1010, audio and gaze data retrieved by the device 2 is filtered based on the wearer profile location and information to determine whether product augmentation information would be useful to the wearer at the wearer's current location and based on the wearer's current gaze and situation. Audio data may be retrieved by input sensors on the device 2 and parsed for information which can be used to supplement presentation of augmentation information. At 1012, input data in the wearer's field of view is analyzed and augmentation information gathered based on the profile settings and context. In one embodiment, more than merely analyzing shopping lists and wearer inventory and other profile information is utilized. The wearer may provide specific settings on when and where augmentation information may be provided. In addition, safety determinations can be made to ensure that it is safe to provide the augmentation information at a particular time. For example, a determination that the wearer is now moving at a certain speed and therefore possibly driving a car can be made so that no augmentation information would appear to block the wearer's view. At a more basic level, the wearer can simply turn the augmentation information on and off through a gesture or audible selection command.

Once augmentation information is matched to the wearer's gaze or audio input, the system can render augmentation information in an appropriate format using visual and/or audio presentations at 1014. Subsequently, at 1015, the method can monitor wearer actions to provide feedback to update the wearer profile and other information. For example, if the wearer actually purchases an item from the shopping list, the item can be removed from the shopping list. If the wearer examines a product and comments that the wearer does not like the product, a rating scale can be updated in the wearer profile, and alternative products suggested. In yet another embodiment, when a wearer looks at a specific product, advertising information offering special deals on the product or alternative products can be rendered in the field of view of the wearer.

FIG. 10B illustrates an alternative method whereby the wearer specifically requests augmentation information. At 1019, the wearer can specifically select to enter a shopping or product browsing mode. This can occur when the wearer is walking through a physical store, walking along the street, or is at home or in a relatively stationary location and merely wishes to shop for products to see how those products might appear in the wearer's own or a different environment. This may include specifically selecting products for which augmentation information is desired. At 1020, the wearer's location, orientation, and gaze, as well as the objects in the wearer's environment are determined. At 1020, a determination may be made that the wearer is at home and wishes to participate in a shopping experience whereby they might see items they are interested in within their own environment. Similarly, the user may be entering a retail facility. At 1021, the wearer's profile is accessed, and personal information is obtained to determine the needs and interests of the wearer. This can include receiving wearer input on products they are seeking and/or obtaining a shopping list from the wearer's profile. In another example, at 1021, an intelligent determination can be made that a user may need access to certain information. For example, if a user profile history indicates that the user has visited a number of car dealerships, and a user is at yet another dealership a determination can be made that car information may be needed. At 1022, audio and/or gaze data is filtered based on the wearer profile to provide product displays or lying in the environment of the wearer. This can include presenting the wearer with a selection of products based on wearer input. At 1024, input data in the wearer's field of view is analyzed to present augmentation based on profile settings in context. The context can include the selection of products which the wearer has previously selected at, for example, step 1019. The final steps are similar to those in FIG. 10A and thus numbered accordingly. At 1014, augmentation information is presented in the wearer's field of view and feedback on the augmentation information is received at 1015 to update the wearer profile and other settings in the system.

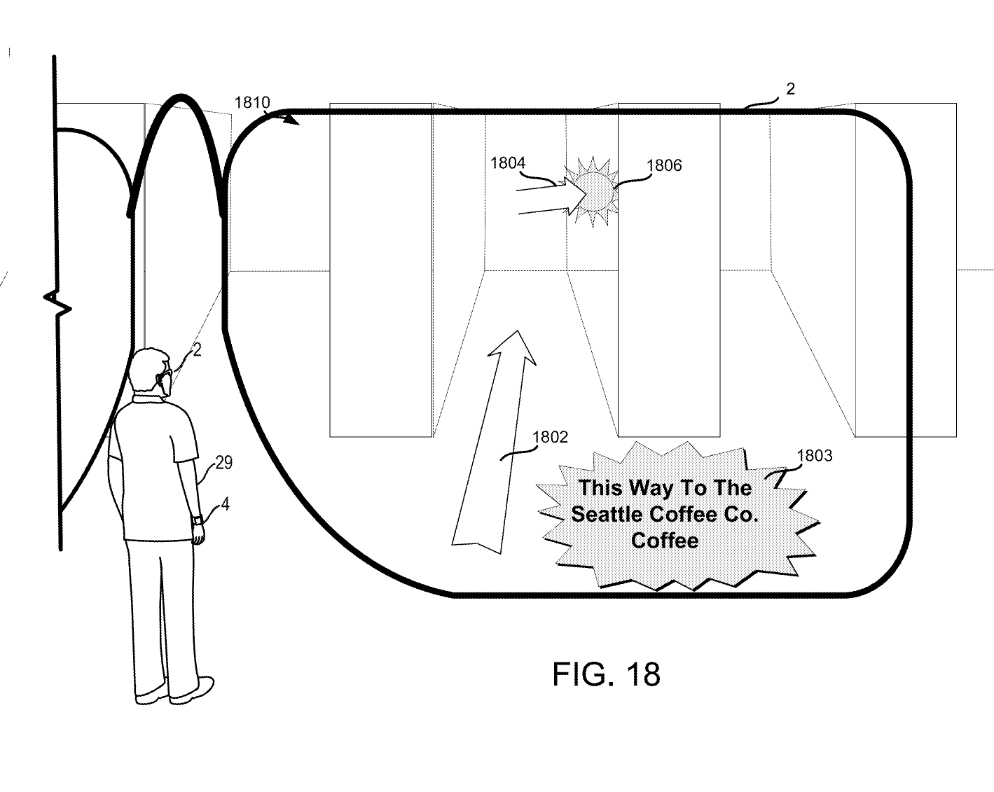

FIG. 11 is a flow chart illustrating the steps of FIG. 10A in additional detail. At step 1102, the wearer location may be determined from GPS and other location-based data. For example, the system may make a general, coarse location e determination by knowing that the wearer's processing device is connected to the wearer's own Wi-Fi network, and use depth information from a camera 20a and/or the display device 2 to itself to determine the more exact location of the wearer within the environment.

At 1104 through 1112, the method of determining gaze and the see-through near-eye mixed reality display system is provided. The method provides an overall view of how a see through head mounted display 2 display device can leverage its geometry of optical components to determine gaze and depth change between the eyeball and the display optical system. One or more processors of the mixed reality systems, such as processor 210 of the control circuitry that in the processing unit 4, mobile device 5, or the hub computing system 12 alone or in combination determine in step 1104 boundaries for a gaze detection coordinate system. In step 1106, a gaze vector for each eye is determined based on reflected eye data, including glints, and in step 1108, a point of gaze, e.g., what the wearer is looking at, is determined for the two eyes in a three-dimensional (3D) wearer field of view. As positions and identity of objects in the wearer's field of view are tracked, any object at a point of gaze in the 3D wearer field of view is identified. In many embodiments, the wearer three-dimensional field of view includes displayed virtual objects and actual direct views of real objects. The term “object” includes a person. At 1110, objects at the point of gaze in the 3D wearer field of view are identified. At 1112, data on the wearer's gaze is retrieved. Objects which are that subject of the wearer's point of gaze are determined at 1112 and used to identify the objects in the wearer's field of view.

As noted previously, following step 1112, at 1008, the wearer's profile is accessed to obtain the wearer profile data discussed above. At 1010, a determination is made as to whether or not augmentation information would be useful to the wearer at the particular location, orientation, and gaze which has been determined. At sub-step 1120, the wearer's profile is parsed for the wearer's schedule, home data, test data, shopping lists, favorites, favorite stores, recent purchases, and preferences that the wearer has defined. For a particular time and a particular location at 1122, a determination is made at 1124 as to whether or not the wearer is close to, in, or on their way to a potential location of interest. The location of interest can be a location of interest to the wearer, or a location of interest to an advertiser or supplemental information provider. For example, if the wearer is in a furniture store, the wearer may be interested in seeing additional information about the objects in the store. If the wearer is on a walk in the neighborhood and there are neighborhood stores offering specials, the wearer may be interested in seeing specials being offered by the neighborhood stores. Subsequently, virtual objects can be placed in the wearer's field of view alerting the wearer to the information which is available, or simply directly providing the information in the form of text, audio, or advertising information available to the wearer. At 1126, a second determination is made as to whether or not the product augmentation would be suitable for the location of interest. As noted above, it is unsafe to provide augmentation information in certain situations, for example, where the wearer is operating machinery or a motor vehicle.

If the factors weighed at steps 1124 and 1126 are met, an augmentation threshold is passed at 1128. The determination steps 1124 and 1126 are repeated for each different time and different location a wearer is actively using the device at 1122. If the augmentation threshold is not met, the method returns to step 1102.

Once the augmentation threshold is met, augmentation data is gathered for the location at 1010. At 1012, sub step 1030, the wearer's gaze is actively determined in accordance with step 1006 and for each gaze at 1130, augmentation information is provided based on profile settings at 1132. It should be understood that the term “augmentation information” includes both information about the wearer products as well as advertising and other incentive-based products, as well as games and interactive advertising. Rendering at 1014 is provided by first determining at 1134 the best output format for augmentation information. Augmentation information can be provided as text, images, animations, games, interactive elements, and the like. Audio data may also be provided. At 1136, any conflicts with other augmentation information which has been provided, or needs to be provided in the future, or which may simultaneously be provided, occurs at 1136. For example, if the wearer looks at a product which comprises two sub-products, such as, for example, a dining room set including a table and chairs, the system may have an option to provide information about both the chair, the table, and the set of information. The determination of conflicts can be based on the wearer's own profile information, information provided by the manufacturer or third-party provider, or by toggling the information based on the wearer's gaze at any particular moment. Finally, at 1138, the audio or visual augmentation information is rendered within the display device 2.

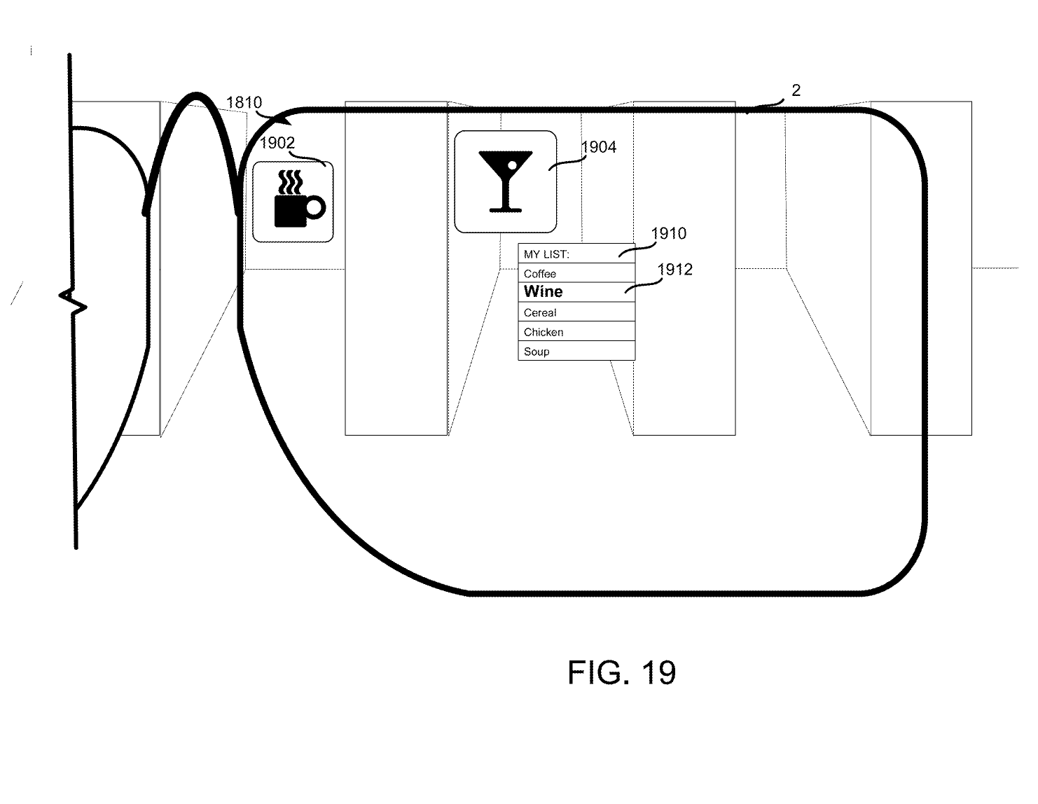

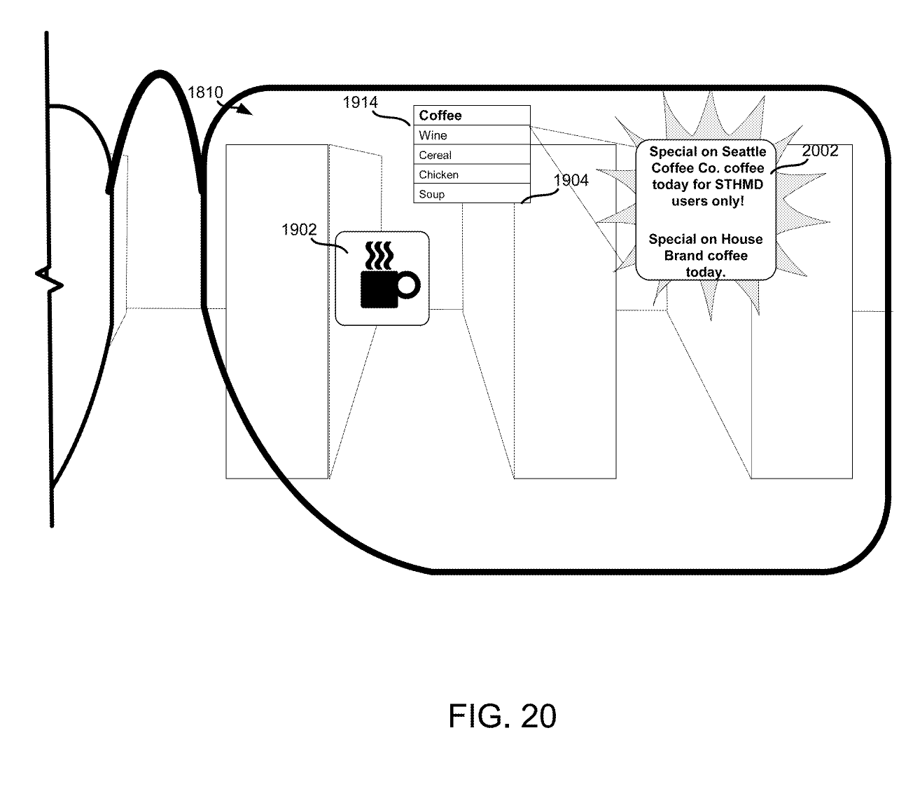

FIGS. 12 and 13 illustrate two methods for determining whether the augmentation threshold at step 1128 has been met. Prior to determining the augmentation threshold, as illustrated in FIG. 12, a wearer interface may be presented at 1202 for preference selection regarding augmentation information at 1204. The wearer interface for preference selection is provided to the wearer in the display device 2, or through an alternative input means, such as a personal computer coupled to the supplemental information provider 903, to allow the wearer to specify times, preferences, blocking times, and other information which would affect the type of information and when the information is presented to the wearer. At 1204, wearer preferences regarding time, place, and types of augmentation are received and stored in a preference file at 1206.

When a determination needs to be made as whether or not an augmentation presentation threshold has been met (step 1128), at step 1208, a first determination is made as to whether or not the preferences allow for presentation of augmentation. If the wearer has set up blocking times, places, advertisers, or only allowed advertisers, or any other type of preference, this information is checked and, if wearer preferences allow such information to be presented, a determination is made at 1210 as to whether or not it is currently safe to present an augmentation. Determination of whether or not it is safe to present augmentation can include determining whether or not the wearer is operating machinery or behind the wheel of a vehicle. If it is safe to present augmentation information, then at 1212 appropriate augmentation based on the surrounding gaze, surrounding audio, place, wearer profile knowledge, and the data to be provided is selected at 1212, and the augmentation threshold is met at 1214.

FIG. 13 presents an alternative situation where a wearer, for example, selects to manually request augmentation information be provided. At 1202, a wearer interface for preference selection of augmentation is presented. At 1220, a manual request, via a gesture or audio command, or other input, is received from the wearer requesting that augmentation information be presented at that particular time and in that particular location. At 1210, an administrative rule determination, such as a safety determination is made, and appropriate augmentation is selected at 1212. If the display may be augmented (i.e. it is safe) and the wearer has manually requested augmentation information, then the augmentation threshold is met at 1214.

At 1210 above, one or more administrative rule-sets may be applied. Each rule set is a set of system level permissions for integration with the wearer experience. The rule-set may comprise a wearer based or admin based control for when and how advertisements are presented to a wearer. Given the context information derived from the see through head mounted display, permissions can be set to control when and where ads can be presented—for example, no advertisement should play when wearer is driving a vehicle or walking, but once a wearer stops, an ad can be presented. This could extend to advertising subject matter (including, for example, age restricted material), time of day, place of presentation, and other display rules.

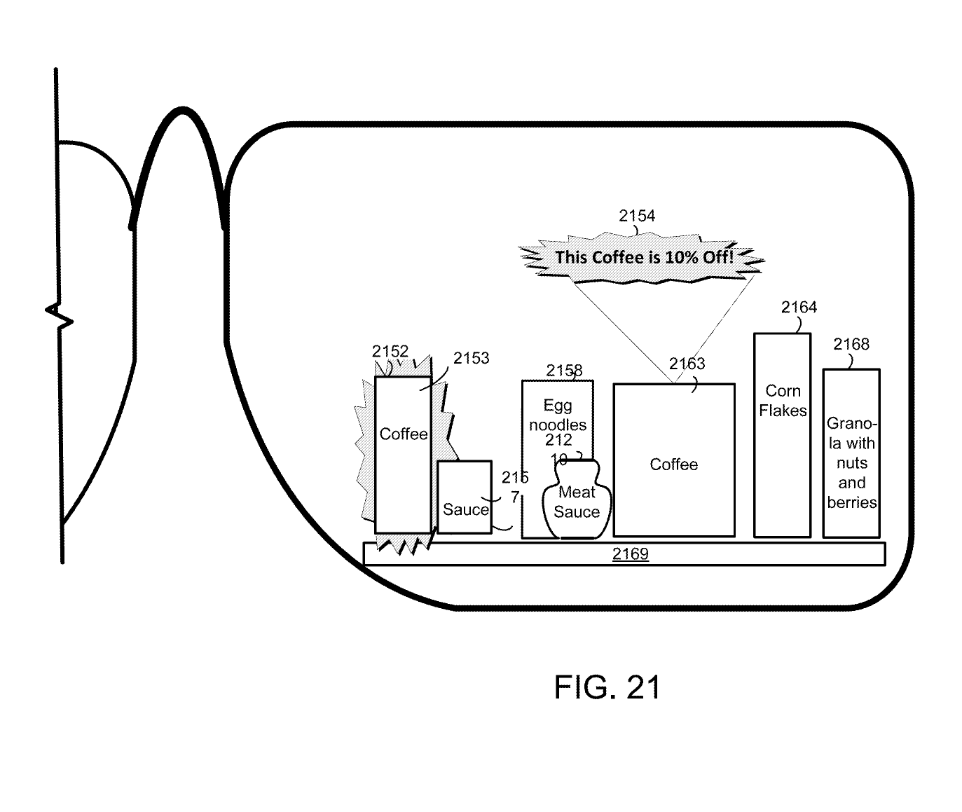

FIG. 14 illustrates a method for performing step 1132 of FIG. 11 providing augmentation information based on the relevant gaze of a wearer. For each wearer gaze at 1406, objects are identified in the wearer view at 1408 and matched to supplemental data or supplemental augmentation information which has been provided and stored by the supplemental information provider 903. At 1412, supplemental information and product augmentation for items which are matched are retrieved. Step 1412 can comprise any number of different types of information and any number of different types of data retrieval. For example, if the specific manufacturer of products are identified, the information retrieved at 1412 can include manufacturer information which has been provided to the supplemental information provider 903 for the specific purpose of delivery to a wearer who has identified the product within the wearer's field of view. Such information can include not only information from a manufacturer but information from retailers, advertising information, and other types of incentives which are provided to the supplemental information provider for targeting to the wearer while the wearer looks at a particular product or is in a particular location. Additional information can include preloaded product reviews which are stored by the supplemental information provider. When a wearer looks at a particular manufacturer's product and the specific product is identified, review information from other wearer s, or from different web sites specializing in product, can be presented as part of the augmentation information. Where no augmentation information is provided, or where additional information is warranted, an Internet search can occur whereby the supplemental information provider causes an information-based search to occur on the world wide web. Other types of information include incentives based on location. Still further, inventory information which indicates that a wearer has purchased the product previously can be used to block advertisements or information for products that the wearer may be viewing and that the wearer already owns. This prevents the wearer from seeing information that the wearer may not care to see, since he already owns the product in question.

At 1414, supplemental information is matched to the objects in the wearer's view. At 1416, product augmentation information based on the object in the wearer's gaze is rendered. At 1420, other objects in the scene, which may require supplemental information in the future, are determined. Additional supplemental and product augmentation information for these products can be retrieved in advance for easy rendering by the display device 2. As such, at 1422, steps 1408, 1412, 1414 can be repeated for upcoming objects identified within the wearer's field of view based on the wearer's gaze. At 1424, upcoming data and object matching information is buffered for use in the next wearer's view. The method repeats for each wearer's gaze on a particular object within the wearer's scene.

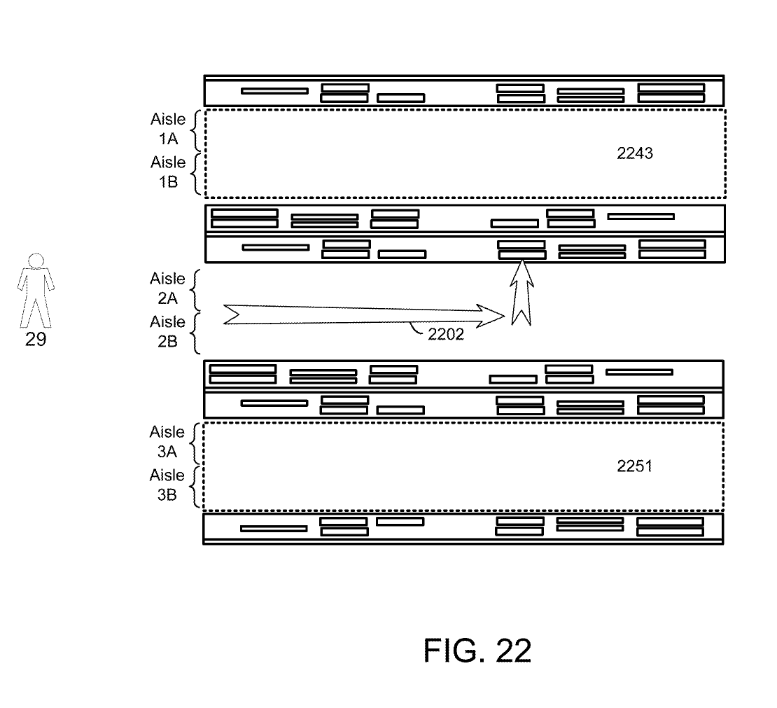

FIG. 15 illustrates a method for using feedback information to modify the type of augmentation information which is presented to a wearer. At 1502, the wearer views of a scene, as well as wearer actions in a scene, wearer purchases, wearer comments, and other gestures are aggregated and matched to known action based on the particular product. For example, if a wearer purchases a particular product, the record of the wearer's purchase is stored. If a wearer picks up a particular product and comments “this is bad,” a determination can be made that the wearer does not particularly like the product. If a wearer looks at particular advertising in a magazine or newspaper, or other media, and stays focused on the advertising product or other point of interest, this can generate a “heat map” which indicates wearer interest in a particular product or advertisement. User views, locations, products, views, and interests are amassed to a frequency heat map 1504, and the frequency heat map can be utilized to aid in the selection of ads at 1506. For example, if the wearer is constantly looking at a particular automobile as that automobile drives by, advertising can be directed to the wearer which presents specials on the particular automobile from local dealers. The wearer conducts interaction with augmentation information, or takes an action on the product or purchases the product, then that interaction is fed back into the system at 1510 and the wearer's profile is modified at 1512. For example, if the wearer actually goes out and buys the car which was the subject of the ad, or selects to interact with an interactive ad provided in the display device 2, the interaction or redemption of such an ad can be utilized to further update the profile, and no additional car ads will be provided to the wearer since the wearer has already purchased a car.

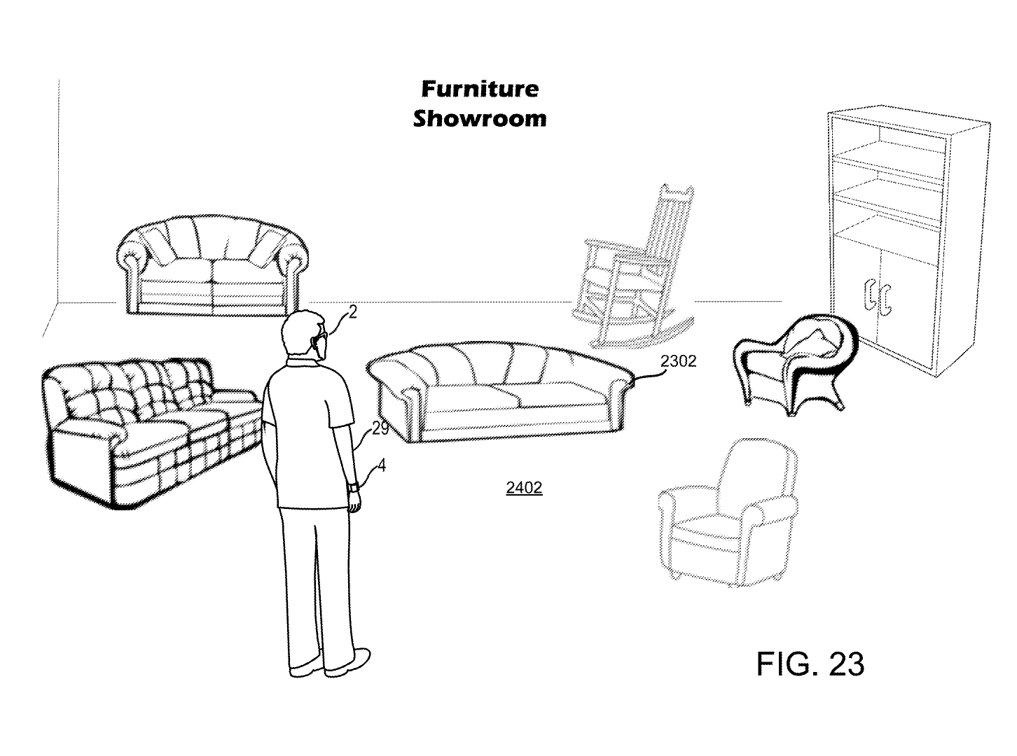

FIG. 16 illustrates the interaction between a personal display apparatus 2 and a supplemental information provider 903. Steps on the left side of FIG. 16 represent the actions of the see through head mounted display 2 while steps on the right side illustrate the actions of a supplemental information provider 903. FIG. 16 represents a case where a wearer interacts with a shopping list at a particular location while wearing a personal display device. At 1602, the wearer connects to the supplemental information provider and authenticates and authorizes the personal display device at 1604. At step 1606, which in one embodiment is equivalent to step 1006, the location, orientation, and gaze of the wearer is determined by the personal display device. Local wearer profile information is accessed, and a task and/or shopping list is obtained at 1608. The lists are displayed at 1610, and the location, orientation, and gaze information is sent to the supplemental information provider 903 at 1614.

The supplemental information provider acts on the information by first accessing location data at 1616. The location data may be associated with augmentation information, which is provided to wearer's at a particular location. At 1618, the location, orientation, and gaze data, which has been provided by the display device, is used to determine what the wearer is looking at in the particular location given in the data that is provided. The wearer profile is accessed at 1620 to determine the inventory and shopping list of the wearer. Items which the wearer may encounter at the particular location and based on the wearer's gaze are retrieved. Items which the wearer has already purchased are blocked from being viewed by the wearer. The location data is filtered based on past experience indicated in the wearer profile at 1622. As noted above, purchased items can be excluded from incentives and advertising while items on the shopping list can be raised in priority for presentation to the wearer. At 1624, information to be displayed to the wearer is prepared. This information can include textual facts, images, videos, incentives, and advertisements. At 1626, an indication of the prepared information to be provided to the wearer is stored in the wearer profile. This can provide a record to the supplemental information provider that the information was presented at one time and the frequency that the information has been provided to the wearer. If a wearer ceases to interact with this information in the future, the priority of providing the information in the future can be lowered. At 1628, the shopping list is updated based on the availability of items at the given location and based on the wearer's orientation and gaze. This information is returned to the display device at 1630. At 1632, the augmentation information is displayed in the see-through display device 2, with the information being provided regarding the object being looked at and display of the shopping list is updated along with relevant advertising and incentive information. At 1634, wearer feedback is monitored to determine whether the wearer interacts with, purchases, or has any other response to either the virtual information or the physical product. As a result of this feedback, the wearer profile is updated at 1636.

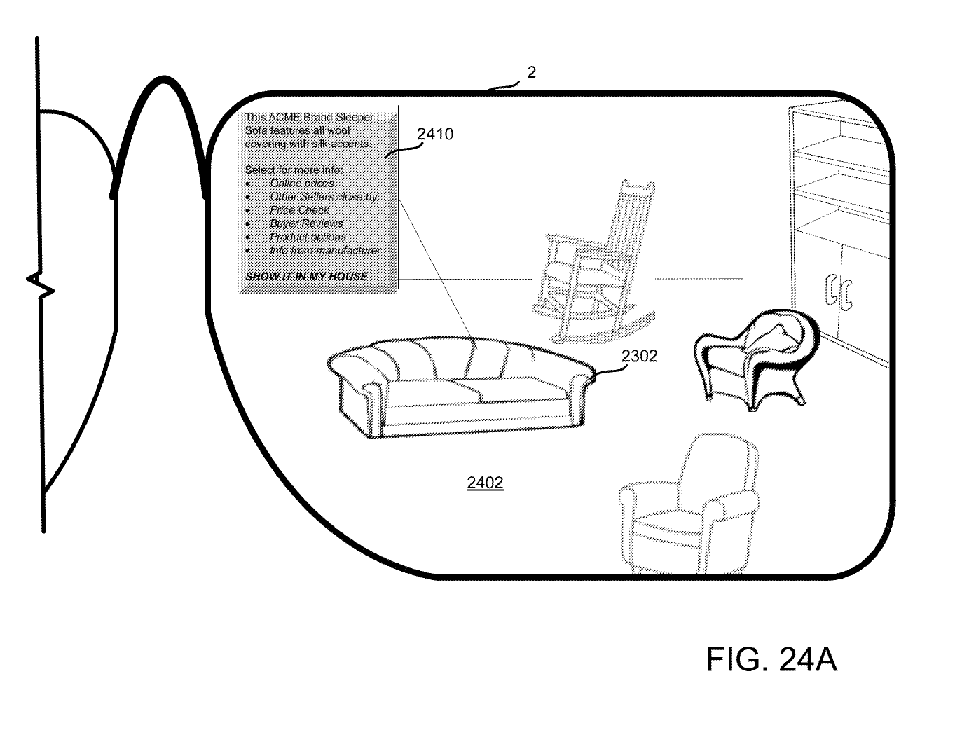

FIG. 17 represents a method for providing advertising information as a specific implementation of augmentation information in accordance with the technology described herein. At 1702, for a given location and gaze, a determination is made at 1704 as to whether or not ads for the location are available. For example, if a wearer enters a grocery store, and the grocery store has provided advertising to a supplemental information provider 903 to provide advertising to wearer's of the display devices, there are ads available for the particular device. Again, subject to the wearer profile information, ads may be available to the wearer. The ads may be targeted or may not be targeted. If the store is running a special on a particular product and wishes that product to be advertised to all wearer's or specifically to wearer's of the display device 2, the supplemental information provider may decide to render this information to the wearer. As the wearer moves through the location, a determination is made as to whether or not a wearer is proximate to an ad location. If the wearer is adjacent to or near an ad location at 1706, then an ad can be displayed within the display device 2. Ads can take many different types of formats, including interactive ads, highlighting, or simply indicating that an item is on sale. Pricing information will be provided if necessary. At 1710, a determination is made as to whether or not the wearer has interacted with the item which is the subject of the ad. If the wearer does interact with the item, this interaction is stored in the wearer profile information, and the system continues to monitor the wearer's movements and gaze by returning to step 1702. If the wearer moves to a location outside of the available advertising area at 1720, and a determination is made that the person is leaving the store without making a purchase, a determination can be made at 1722 as to whether other items on the wearer's interest list are available within the store and advertising can be directed to the wearer, incentivizing the wearer to return to the store at 1724. For example, if a wearer is known to be in the market for a car, and the wearer is leaving a car dealership without making a purchase, the car dealership can direct advertising to the wearer offering an additional discount before the wearer leaves the store without making a purchase.

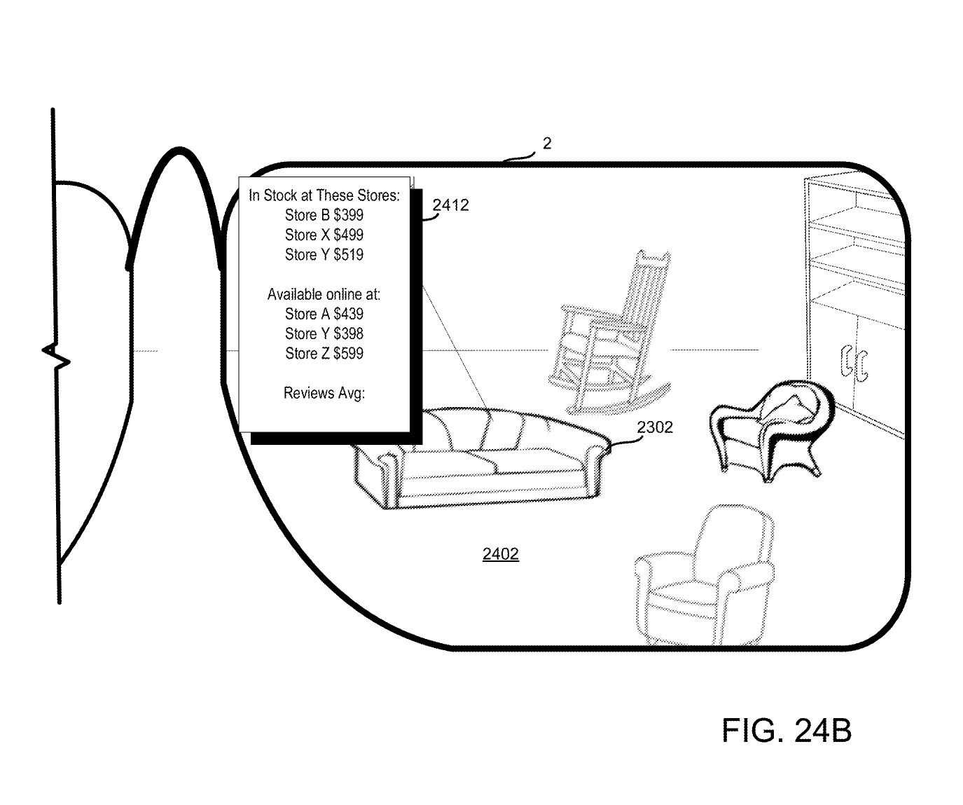

FIGS. 18 to 30 illustrate various types of augmentation information and advertising which can be provided to a wearer in concordance with the present technology.

FIG. 18 illustrates the wearer who has entered a store, such as a grocery store, at 1810. As the wearer enters the store, the technology herein has determined that the wearer is in the market for coffee. User 29 is wearing see through head mounted display 2, which may include, for example, a processing unit 4. In one aspect, the wearer may have specified that verbally that “I'm going into the store for coffee,” or coffee may be on the wearer's shopping list, or the system knows that the consumer regularly buys a particular type of coffee. In FIG. 18, the augmentation information provided is a direction 1802, 1804 and a highlight 1806 showing the way to the consumer through the aisles to the wearer's particular brand of coffee, in this case the “Seattle Coffee Company coffee.” An additional message 1803 may tell the wearer that the highlight is to direct him to the Seattle Coffee Company product. Any manner of highlights or mappings may be utilized in accordance with this concept. The concept may be utilized in any of a number of different types of stores. The concept may be utilized through store walls. For example, wearer 29 may be outside of the store and may be looking into or walking past a grocery store which has a special on Seattle Coffee Company's coffee. As the wearer turns his head and looks into the store, the highlight indicator 1806 may glow, telling the wearer that this store is having a special on Seattle Coffee Company coffee. Additional highlight information, such as that shown in FIG. 20, may be presented to the wearer to incentivize the wearer to enter the store and purchase the coffee.

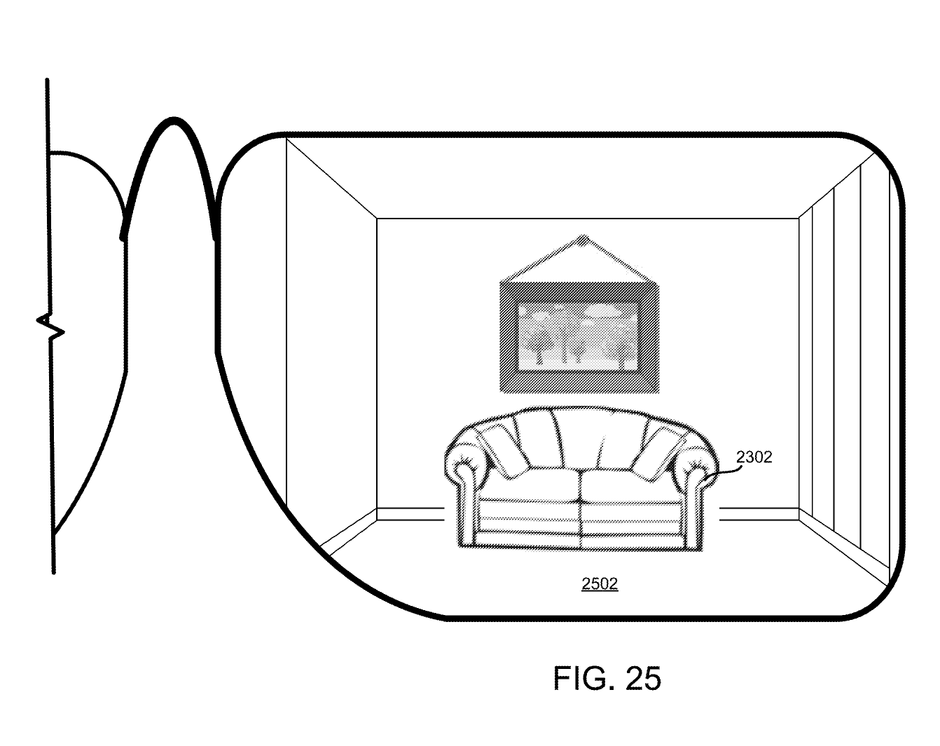

FIG. 19 illustrates two different types of views a wearer may encounter when entering the grocery store 1810. Icons or highlights 1902, 1904 tell the wearer where particular items on the wearer's shopping list might be located in the store. Alternatively, these icons can be augmentations provided by the store directing the wearer to either items on the shopping list, items which the store wishes the wearer to be directed to based on advertising, or simply a store directory allowing the wearer to more easily navigate the store for products that might be on the wearer's shopping list, or to navigate a store which the wearer has never been in before. In addition, in FIG. 19, the wearer's shopping list in a list format is shown at 1910. Highlighted items 1912 can show the wearer items which the wearer is proximately close to, or, when the wearer is looking in the direction of the wine aisle, as indicated by the wine icon 1904, the wine item 1912 on the wearer's shopping list may be highlighted to indicate to the wearer that the wine is closer than other items on the list and can be more easily retrieved based on the wearer's distance to the wine. This indicator can be used alone or in conjunction with the highlighting displayed in FIG. 18 as well as FIGS. 20 through 21 in various embodiments of the present technology.

FIG. 20 illustrates another method of highlighting items in a grocery store 1810 to a wearer. Similar to FIG. 19, an icon can be used to indicate the presence of the coffee aisle to the wearer. Similarly, the wearer's shopping list is presented and the highlighted item 1914 is the item “coffee.” In conjunction with highlighting of the coffee item, an advertisement 2002 is shown to the wearer within the display device 2. This advertisement indicates there is a “Special” on Seattle Coffee Company coffee today for see-through head-mounted display device wearer's only. In addition, there is a special on House Brand coffee. Targeted advertising directly to wearers of display devices 2 rather than other wearer's in the store can be a feature associated with the present technology. The advertising can direct the wearer specifically to the location of the product using any of the aforementioned mechanisms or the method shown in FIG. 21.

FIG. 21 shows a shelf 2169 comprising a number of products. The coffee product 2153 is highlighted 2152 within the wearer's view as the wearer gets closer to the particular product. Advertising 2154 can be shown for competing products 2163 even though the wearer's preferred product is highlighted at 2152. Any different manner of highlighting items can be utilized, including presenting a glowing box around a particular product, dimming the view of other products, presenting animations on top of preferred products, and the like. In FIG. 21, the products and the advertisements are highlighted.

FIG. 22 shows an alternative means of directing a wearer to a product instead of using a three-dimensional map, such as that shown in FIG. 18, an overlay map 2200 is utilized. User 29 can be directed using an overhead map and a two-dimensional guide 2202 to direct a wearer to the coffee product. In a manner similar to that discussed above with respect to FIGS. 18 through 21, any manner of highlighting the product can be utilized to direct to wearer specifically the product in question. In addition, advertising can be presented over the two-dimensional map so that the wearer is incentivized to move to the particular product which is designed to be highlighted in the map.

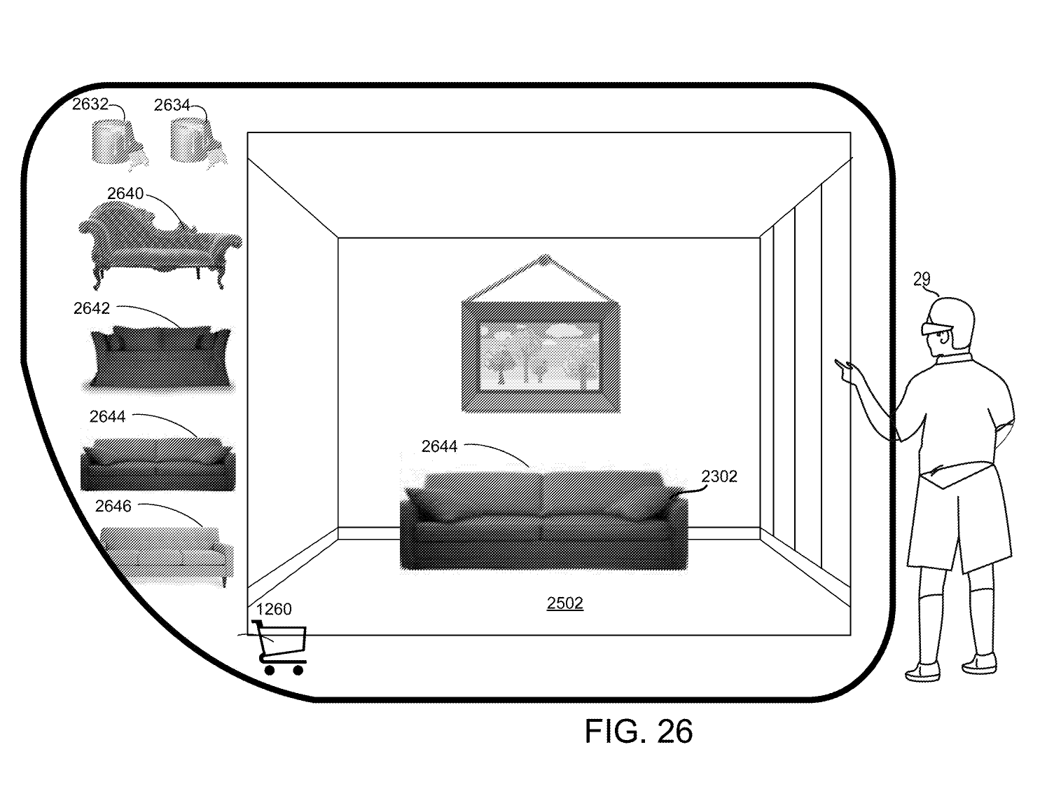

FIG. 23 illustrates another alternative use of the technology providing augmentation information to a wearer. In FIG. 23, wearer 29 has entered a store, such as a furniture store displaying a number of pieces of furniture, during which the wearer's gaze fixes on a sofa 2302.

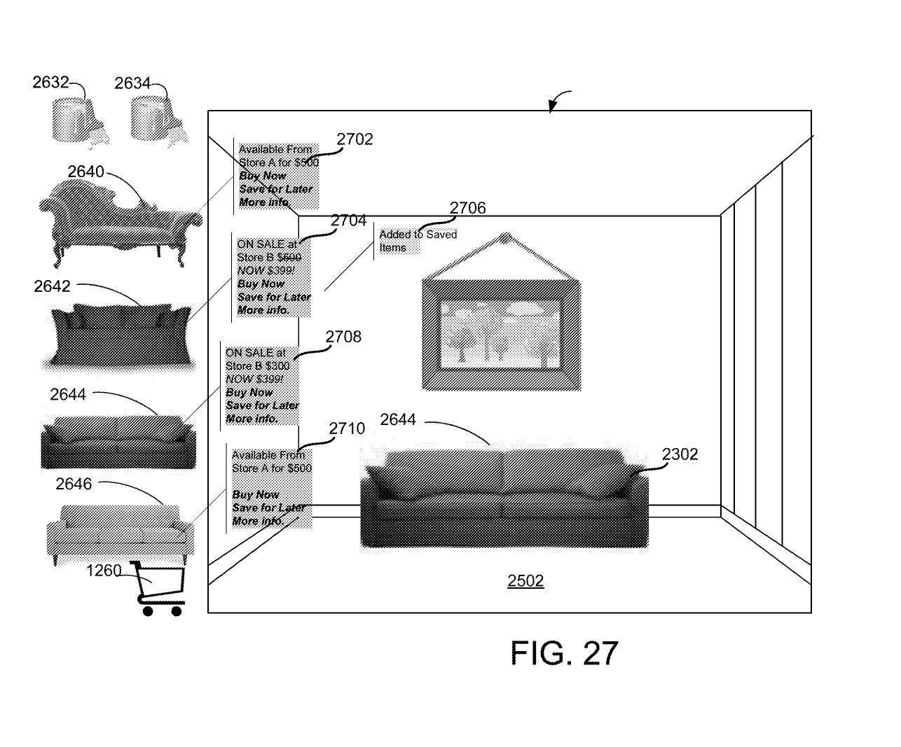

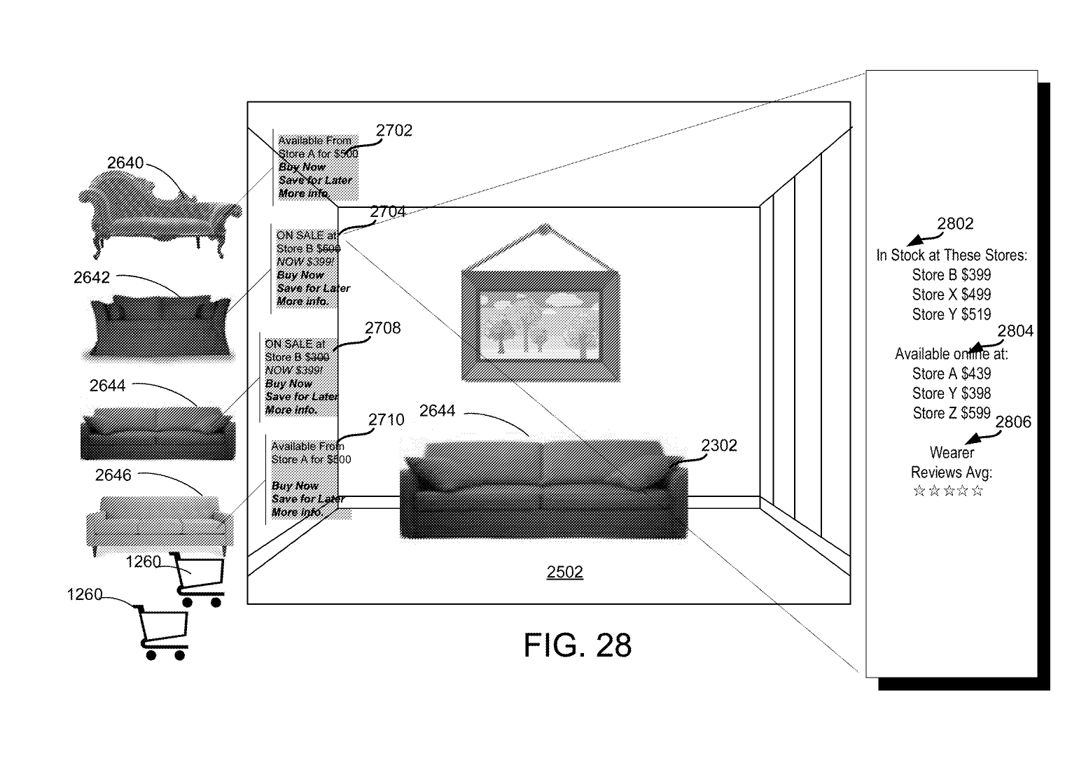

FIG. 24A represents one example wearer's view of the sofa 2302 within the furniture store 2402. W the wearer fixes his gaze on the sofa 2302, augmentation information 2410 can be provided. In this case, the augmentation information presented is a description of the sofa 2302 along with a menu allowing the wearer to select any of a number of different types of augmentation information which can additionally be presented in the view of the display device 2. In item 2410, the wearer has a number of choices that the wearer can make by simply selecting the virtual menu item on the virtual menu 2410. The wearer can select more information for the “online prices,” “other sellers close by,” “price check,” “buyer reviews,” “product options,” and “info from the manufacturer.” Another option allows the wearer to “show it in my house.” Selecting any of the menu items will result in actions which are generally described by the menu items. For example, selecting “online prices” will render a list of online prices that are available from online retailers for the sofa 2302. Clicking “other sellers close by” will provide a list of other sellers within a small geographical radius of the store 2402. Clicking “price check” will provide a list of other retailers who have the same item and the prices they are selling them for. Selecting “buyer reviews” will either provide a list of buyer reviews, actual text of buyer reviews, or a menu item allowing the wearer to select from various buyer reviews to review the reviews prior to making a purchase of the sofa 2302. Selecting “product options” could show the wearer a list of types of fabrics and color options which are available for a particular product. The type of product options which are available for different types of products can vary greatly based on the type of product. Selecting “info from the manufacturer” can provide a product brochure or other information which has been provided by the manufacturer and which is specific to the product 2302.

FIG. 24b represents an example of the information provided by selecting the “price check’ option in FIG. 24a. As shown in FIG. 24B, this option can display a selection of stores which have the same item in stock as well as online (Web-based) sellers that are selling the product. In addition, online reviews can be presented in 2412. Any number of augmentation information types can be presented in accordance with the teachings of FIGS. 24A and 24B.

FIG. 25 shows the result of the “show it in my house” link in FIG. 24. FIG. 25 shows the display of the sofa 2302 in the wearer's living room 2502. In FIG. 25, the living room represented at 2502 is wearer 29's own living room. In this manner, the wearer viewing an object in a retail store can, upon selection of a particular menu item or verbal command, have that item displayed to the wearer in the display device in the wearer's own particular environment, or any environment. In this manner, modeling information which is known to the supplemental information provider regarding the wearer's view and the wearer's domicile can be utilized to place either the object which is displayed to the wearer in the store based on the wearer's view, or, using two- or three-dimensional models provided by the manufacturer, the system can render the object, in this case sofa 2302, within the wearer's model in the display device 2 while the wearer is either in the store, or, as discussed below, while the wearer is performing virtual shopping in the wearer's own home. It should be understood that the command to show it in my house can be utilized for any number of different types of locations and operations.

FIG. 26 illustrates a wearer 29 conducting a shopping exercise utilizing augmented data in the wearer's own living room 2502. Upon selection of a command to interact with an online shopping experience, the wearer may be presented with a series of options for sofas (or other products desired by the wearer) in a menu. The products may include alternative sofas 2640, 2642, 2644, 2646, as well as commands to initiate a color scheme change in the living room 2502 and an interactive shopping and purchasing experience 1260. User 29 is staring at the wearer's living room 2502, and a selection of sofas is presented to the wearer in display device 2. The wearer, through gestures, audio commands or other types of input, can select different sofas for presentation in the wearer's living room 2502. The wearer can also select to change the color or background by selecting icons 2532, 2634 in the selection window. The wearer can simply drag and drop items from a selection menu on the left-hand side of the display into the wearer's living room. In this manner, the wearer can see selected products that the wearer wishes to view before actually viewing them in a physical store.

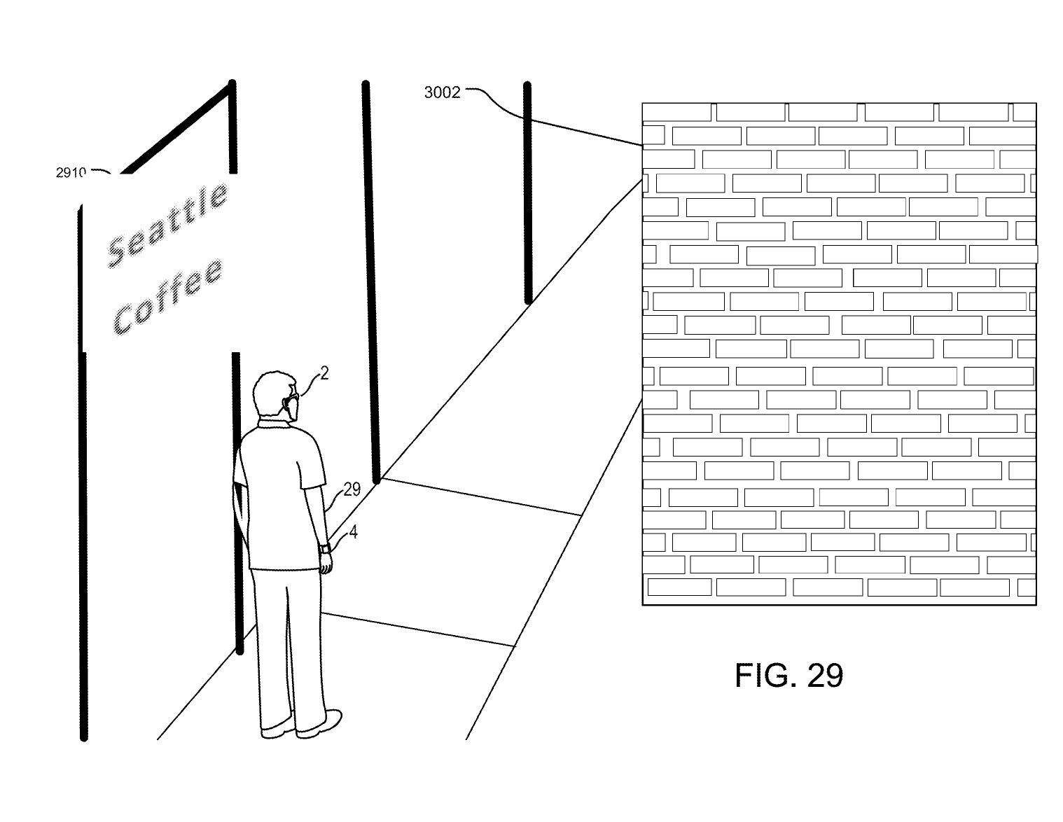

FIGS. 27 and 28 illustrate different types of data which can be augmented along with a presentation to the wearer in the display device 2. As shown in FIG. 27, for each of the sofas 2640, 2642, 2644, 2646 in the display device, information such as where the device is available from, where it is on sale, and menu items allowing the wearer to select an item to be saved for later use, buy now, or select more info, can be presented. Note that the interface shown in FIGS. 27 and 28 can be provided to the wearer whether the wearer is at home and shopping, or whether the wearer is actually in the store. In the store environment, such as that shown in FIG. 24, the wearer can drag items from the physical location of the store into the virtual environment presented in the display device 2. For example, using a specific gesture or audible command, the wearer can select a particular product within the store and drag that store/product into the wearer's virtual living room. Information such as that shown in FIG. 27 can be augmented by information such as that shown in FIG. 28.

FIG. 28 shows an example list of additional stores 2802, which have the item in stock, the prices of the item, and the average wearer rating 2806 for people who have reviewed this particular item.

Note that the wearer can also manually select not to have additional advertisements or information provided about particular products while the wearer is reviewing the products or wearing the display apparatus 2.

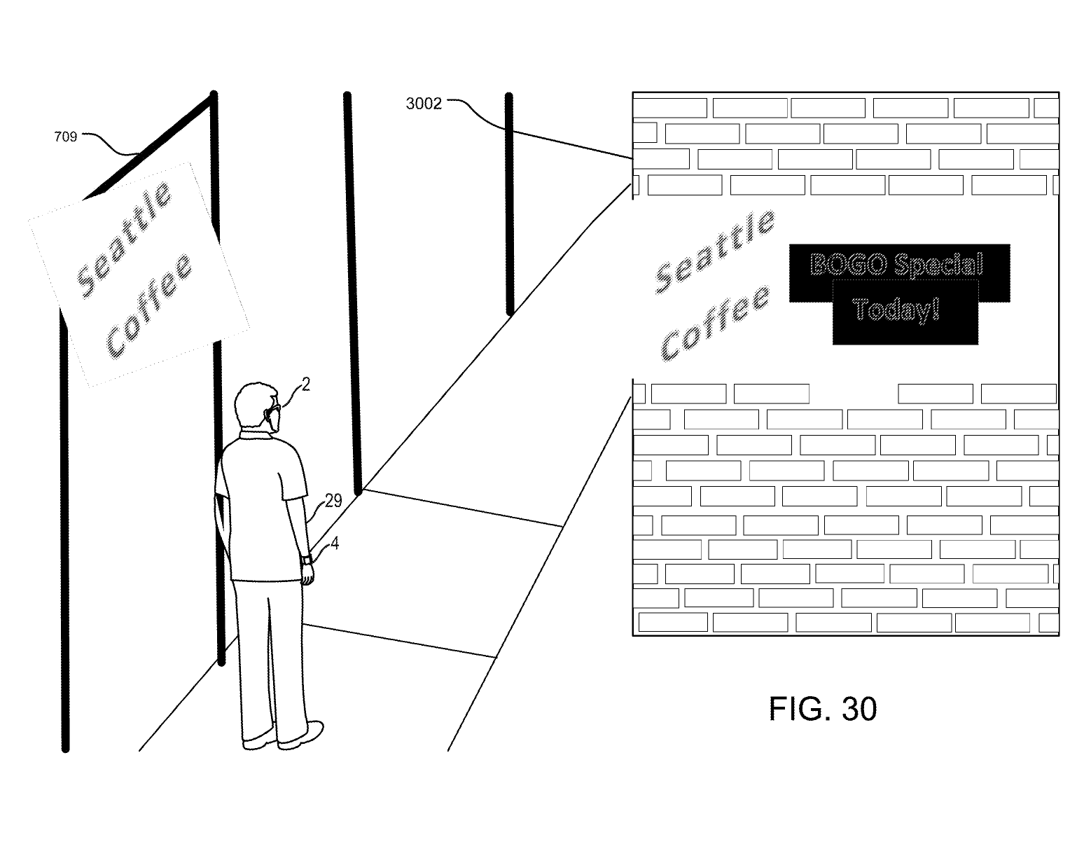

FIGS. 29 through 31 illustrate the presentation of advertising to a wearer as a wearer is walking past an area where targeting advertising has been specified by a third-party provider. In FIG. 29, a wearer 29 is shown walking along the street 2900 would see a brick wall 2902 and a sign indicating that the wearer is passing the Seattle Coffee Company at 2910. Elements shown in FIG. 29 are those one would see without the aid of a display device 2 or personal audiovisual apparatus.

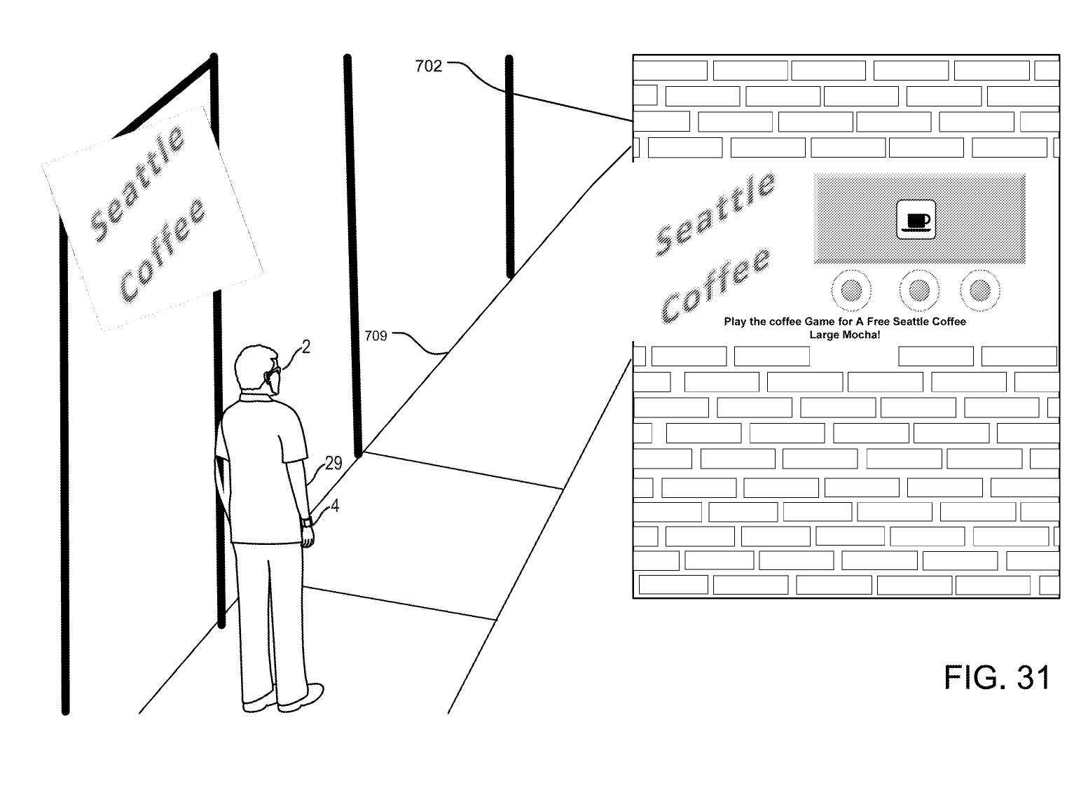

FIG. 30 shows a first example of an alternative view of supplemental information a wearer sees with a display device 2. Using the display apparatus 2, a virtual advertisement 3002, shown in FIG. 30, can be presented on an adjacent wall directing the wearer into the Seattle Coffee Company. In this case, the ad 3002 shows on or over a portion of the wall 3004, and indicates that the Seattle Coffee Company is offering a buy-one-get-one-free (BOGO) offer for drinks. The advertising may be accompanied by audio or visual cues to draw the wearer's attention to the advertisement. For example, music may play or an alert may sound indicating that the advertisement has sprung up.

As illustrated in FIG. 31, the advertising can be interactive. FIG. 31 illustrates an advertisement 3102 wherein the wearer must play a game and, as a result of the game, could be rewarded with a free Seattle Coffee Company large mocha or additional prizes, including discounts. Various types of interactive advertising can be provided in addition to that shown herein.

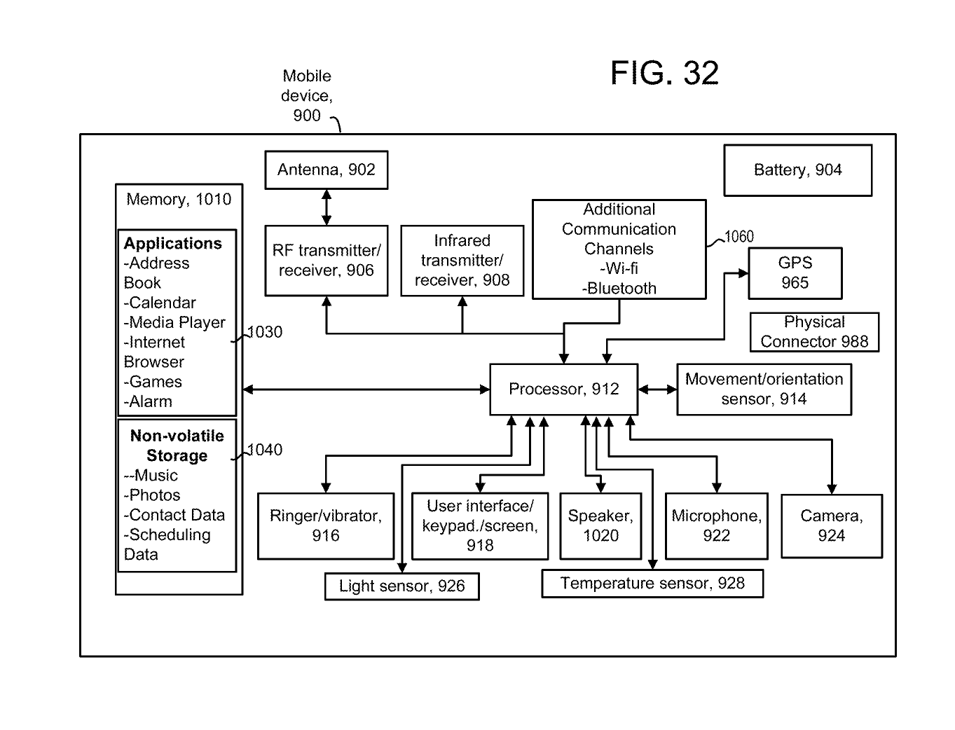

FIG. 32 is a block diagram of an exemplary mobile device which may operate in embodiments of the technology described herein (e.g. device 5). Exemplary electronic circuitry of a typical mobile phone is depicted. The phone 3200 includes one or more microprocessors 3212, and memory 1010 (e.g., non-volatile memory such as ROM and volatile memory such as RAM) which stores processor-readable code which is executed by one or more processors of the control processor 3212 to implement the functionality described herein.

Mobile device 3200 may include, for example, processors 3212, memory 1050 including applications and non-volatile storage. The processor 3212 can implement communications, as well as any number of applications, including the interaction applications discussed herein. Memory 1010 can be any variety of memory storage media types, including non-volatile and volatile memory. A device operating system handles the different operations of the mobile device 3200 and may contain wearer interfaces for operations, such as placing and receiving phone calls, text messaging, checking voicemail, and the like. The applications 1030 can be any assortment of programs, such as a camera application for photos and/or videos, an address book, a calendar application, a media player, an Internet browser, games, other multimedia applications, an alarm application, other third party applications, the interaction application discussed herein, and the like. The non-volatile storage component 1040 in memory 1010 contains data such as web caches, music, photos, contact data, scheduling data, and other files.

The processor 3212 also communicates with RF transmit/receive circuitry 3206 which in turn is coupled to an antenna 3202, with an infrared transmitted/receiver 3208, with any additional communication channels 1060 like Wi-Fi or Bluetooth, and with a movement/orientation sensor 3214 such as an accelerometer. Accelerometers have been incorporated into mobile devices to enable such applications as intelligent wearer interfaces that let wearer's input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 3212 further communicates with a ringer/vibrator 3216, a wearer interface keypad/screen, biometric sensor system 3218, a speaker 1020, a microphone 3222, a camera 3224, a light sensor 3226 and a temperature sensor 3228.

The processor 3212 controls transmission and reception of wireless signals. During a transmission mode, the processor 3212 provides a voice signal from microphone 3222, or other data signal, to the RF transmit/receive circuitry 3206. The transmit/receive circuitry 3206 transmits the signal to a remote station (e.g., a fixed station, operator, other cellular phones, etc.) for communication through the antenna 3202. The ringer/vibrator 3216 is used to signal an incoming call, text message, calendar reminder, alarm clock reminder, or other notification to the wearer. During a receiving mode, the transmit/receive circuitry 3206 receives a voice or other data signal from a remote station through the antenna 3202. A received voice signal is provided to the speaker 1020 while other received data signals are also processed appropriately.

Additionally, a physical connector 3288 can be used to connect the mobile device 3200 to an external power source, such as an AC adapter or powered docking station. The physical connector 3288 can also be used as a data connection to a computing device. The data connection allows for operations such as synchronizing mobile device data with the computing data on another device.

A GPS transceiver 3265 utilizing satellite-based radio navigation to relay the position of the wearer applications is enabled for such service.

The example computer systems illustrated in the Figures include examples of computer readable storage media. Computer readable storage media are also processor readable storage media. Such media may include volatile and nonvolatile, removable and non-removable media implemented in any method or technology for storage of information such as computer readable instructions, data structures, program modules or other data. Computer storage media includes, but is not limited to, RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other medium which can be used to store the desired information and which can accessed by a computer.

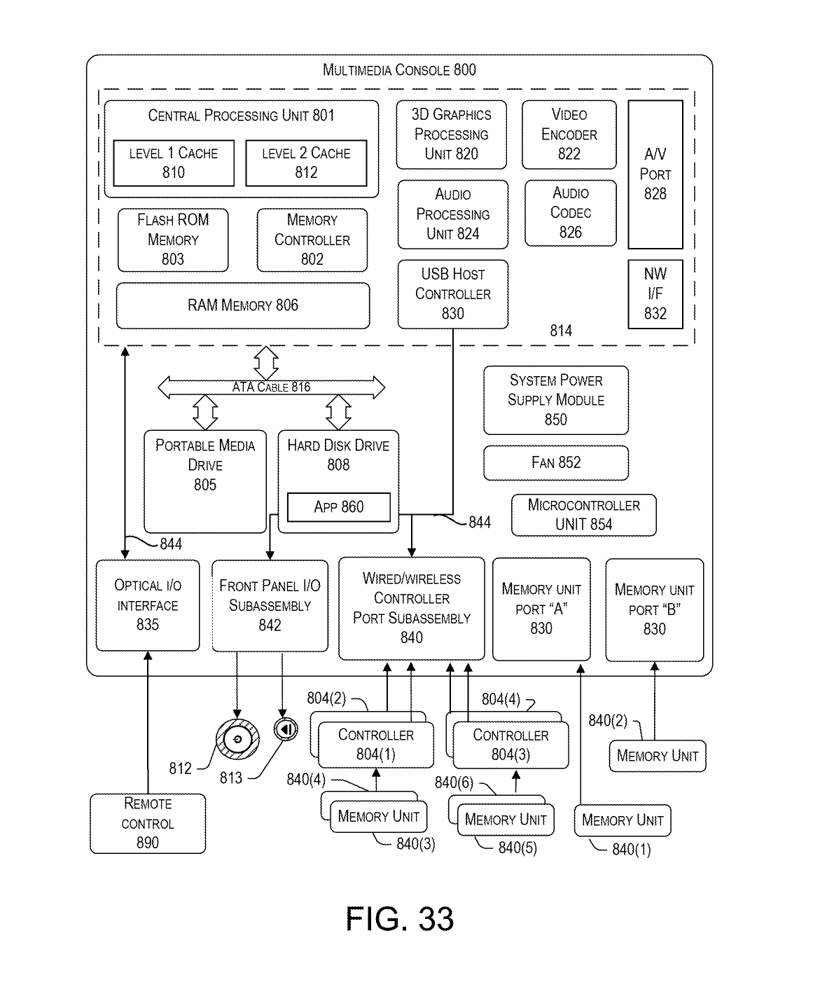

FIG. 33 is a block diagram of one embodiment of a computing system that can be used to implement a hub computing system like that of FIGS. 1A and 1B. In this embodiment, the computing system is a multimedia console 700, such as a gaming console. As shown in FIG. 18, the multimedia console 700 has a central processing unit (CPU) 701, and a memory controller 702 that facilitates processor access to various types of memory, including a flash Read Only Memory (ROM) 703, a Random Access Memory (RAM) 706, a hard disk drive 708, and portable media drive 706. In one implementation, CPU 701 includes a level 1 cache 710 and a level 2 cache 712, to temporarily store data and hence reduce the number of memory access cycles made to the hard drive 708, thereby improving processing speed and throughput.

CPU 701, memory controller 702, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 701, memory controller 702, ROM 703, and RAM 706 are integrated onto a common module 714. In this implementation, ROM 703 is configured as a flash ROM that is connected to memory controller 702 via a PCI bus and a ROM bus (neither of which are shown). RAM 706 is configured as multiple Double Data Rate Synchronous Dynamic RAM (DDR SDRAM) modules that are independently controlled by memory controller 702 via separate buses (not shown). Hard disk drive 708 and portable media drive 705 are shown connected to the memory controller 702 via the PCI bus and an AT Attachment (ATA) bus 716. However, in other implementations, dedicated data bus structures of different types can also be applied in the alternative.

A graphics processing unit 720 and a video encoder 722 form a video processing pipeline for high speed and high resolution (e.g., High Definition) graphics processing. Data are carried from graphics processing unit (GPU) 720 to video encoder 722 via a digital video bus (not shown). Lightweight messages generated by the system applications (e.g., pop ups) are displayed by using a GPU 720 interrupt to schedule code to render popup into an overlay. The amount of memory used for an overlay depends on the overlay area size and the overlay preferably scales with screen resolution. Where a full wearer interface is used by the concurrent system application, it is preferable to use a resolution independent of application resolution. A scaler may be used to set this resolution such that the need to change frequency and cause a TV resync is eliminated.

An audio processing unit 724 and an audio codec (coder/decoder) 726 form a corresponding audio processing pipeline for multi-channel audio processing of various digital audio formats. Audio data are carried between audio processing unit 724 and audio codec 726 via a communication link (not shown). The video and audio processing pipelines output data to an A/V (audio/video) port 728 for transmission to a television or other display. In the illustrated implementation, video and audio processing components 720-828 are mounted on module 214.

FIG. 31 shows module 714 including a USB host controller 730 and a network interface 732. USB host controller 730 is shown in communication with CPU 701 and memory controller 702 via a bus (e.g., PCI bus) and serves as host for peripheral controllers 704(1)-804(4). Network interface 732 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 21 console 700 includes a controller support subassembly 740 for supporting four controllers 704(1)-804(4). The controller support subassembly 740 includes any hardware and software components needed to support wired and wireless operation with an external control device, such as for example, a media and game controller. A front panel I/O subassembly 742 supports the multiple functionalities of power button 712, the eject button 713, as well as any LEDs (light emitting diodes) or other indicators exposed on the outer surface of console 702. Subassemblies 740 and 742 are in communication with module 714 via one or more cable assemblies 744. In other implementations, console 700 can include additional controller subassemblies. The illustrated implementation also shows an optical I/O interface 735 that is configured to send and receive signals that can be communicated to module 714.

MUs 740(1) and 740(2) are illustrated as being connectable to MU ports “A” 730(1) and “B” 730(2) respectively. Additional MUs (e.g., MUs 740(3)-840(6)) are illustrated as being connectable to controllers 704(1) and 704(3), i.e., two MUs for each controller. Controllers 704(2) and 704(4) can also be configured to receive MUs (not shown). Each MU 740 offers additional storage on which games, game parameters, and other data may be stored. In some implementations, the other data can include any of a digital game component, an executable gaming application, an instruction set for expanding a gaming application, and a media file. When inserted into console 700 or a controller, MU 740 can be accessed by memory controller 702. A system power supply module 750 provides power to the components of gaming system 700. A fan 752 cools the circuitry within console 700. A microcontroller unit 754 is also provided.

An application 760 comprising machine instructions is stored on hard disk drive 708. When console 700 is powered on, various portions of application 760 are loaded into RAM 706, and/or caches 710 and 712, for execution on CPU 701, wherein application 760 is one such example. Various applications can be stored on hard disk drive 708 for execution on CPU 701.

Gaming and media system 700 may be operated as a standalone system by simply connecting the system to monitor 16 (FIG. 1A), a television, a video projector, or other display device. In this standalone mode, gaming and media system 700 enables one or more players to play games, or enjoy digital media, e.g., by watching movies, or listening to music. However, with the integration of broadband connectivity made available through network interface 732, gaming and media system 700 may further be operated as a participant in a larger network gaming community.

The system described above can be used to add virtual images to a wearer's view such that the virtual images are mixed with real images that the wearer see. In one example, the virtual images are added in a manner such that they appear to be part of the original scene. Examples of adding the virtual images can be found U.S. patent application Ser. No. 13/112,919, “Event Augmentation With Real-Time Information,” filed on May 20, 2011; and U.S. patent application Ser. No. 12/905,952, “Fusing Virtual Content Into Real Content,” filed on Oct. 15, 2010; both applications are incorporated herein by reference in their entirety.

Technology is presented below for augmenting a wearer experience at various situations. In one embodiment, an information provider prepares supplemental information regarding actions and objects occurring within an event. A wearer wearing an at least partially see-through, head mounted display can register (passively or actively) their presence at an event or location and a desire to receive information about the event or location.

In one embodiment, the personal A/V apparatus 902 can be head mounted display device 2 (or other A/V apparatus) in communication with a local processing apparatus (e.g., processing unit 4 of FIG. 1A, mobile device 5 of FIG. 1B or other suitable data processing device). One or more networks 906 can include wired and/or wireless networks, such as a LAN, WAN, WiFi, the Internet, an Intranet, cellular network etc. No specific type of network or communication means is required.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method providing augmentation information to a wearer, comprising:
(a) displaying a list of products on a head mounted display device while at an establishment having a plurality of products including at least some of the products on the list of products;
(b) determining a location in the establishment of a product on the list of products;
(c) presenting augmentation information via the head mounted display facilitating purchase of the product whose location was determined in said step (b).

2. The method of claim 1 wherein presenting augmentation information comprises the step of directing the wearer to a location of the product whose location was determined in said step (b).

3. The method of claim 1 wherein presenting augmentation information comprises the step of displaying the location of the product within the establishment.

4. The method of claim 1 wherein presenting augmentation information comprises the step of audibly relaying the location of the product within the establishment.

5. The method of claim 1 wherein presenting augmentation information comprises the step of highlighting the product on the list of products when the wearer is in the vicinity of the product.

6. The method of claim 1 wherein presenting augmentation information comprises the step of highlighting the product on the list of products when the wearer is gazing in a direction in which the product is located.

7. The method of claim 1 wherein presenting augmentation information comprises the step of displaying an advertisement as incentive for a wearer to purchase the product.

8. The method of claim 7 wherein the advertisement is not available unless viewed on the head mounted display device.

9. The method of claim 1 wherein the augmentation information is based on the wearer's location relative to the product and the information is displayed when the wearer is gazing at a matched product.

10. A method providing augmentation information to a wearer, comprising:
(a) displaying a list of products on a head mounted display device while at an establishment having a plurality of products including at least some of the products on the list of products;
(b) determining locations in the establishment of the at least some products on the list of products;
(c) highlighting a product on the list of products displayed to the wearer when the wearer is in a vicinity of a location of the product within the establishment.

11. The method of claim 10, further comprising the step of highlighting a product on the list of products displayed to the wearer when the wearer is gazing in the direction of the product within the establishment.

12. The method of claim 10, further comprising the step of displaying augmentation information to the wearer relating to the highlighted product.

13. The method of claim 10, further comprising the step of displaying augmentation information to the wearer relating to the highlighted product.

14. The method of claim 13, further comprising the step of displaying an icon indicating a location of the product.

15. The method of claim 13, further comprising the step of displaying an advertisement for the product.

16. A system for providing augmentation information to a wearer, comprising:
a head mounted display device operable to display a list of products to the wearer;
a processer associated with the head mounted display device, the processor receiving information relating to one or more locations within an establishment of one or more products on the list of products, the processor presenting augmentation information via the head mounted display facilitating purchase of the one or more products.

17. The system of claim 16, wherein the processor presenting augmentation information comprises the processor directing the wearer to a location of the one or more products.

18. The system of claim 16, wherein the processor presenting augmentation information comprises the processor displaying a location of the one or more products on the head mounted display device.

19. The system of claim 16, wherein the processor presenting augmentation information comprises the processor causing a product of the one or more products to be highlighted when displayed in the list of products by the head mounted display device.

20. The system of claim 16, wherein the processor presenting augmentation information comprises the processor displaying an advertisement relating to the one or more products on the head mounted display device.
